(19) United States
(12) Patent Application Publication
(10) Pub. No.: US 2008/0122623 A1
(43) Pub. Date: May 29, 2008

(54) System and method for tracing data storage devices

(76) Inventors: Curtis B. Hause, St. Paul, MN (US); Stephen J. Rothermel, Roseville, MN (US); Jody L. Gregg, Lake Elmo, MN (US); G. Phillip Rambosek, Shafer, MN (US); Yung Yip, Afton, MN (US); Robert C. Martin, St. Paul, MN (US); Christopher Caprio, Stillwater, MN (US); Karen E. Conroy, Oakdale, MN (US); Sanjay Gupta, Woodbury, MN (US); Kevin G. Battles, Wahpeton, ND (US); Denis J. Langlois, River Falls, WI (US)

Correspondence Address: Imation Corp., PO Box 64898, St. Paul, MN, 55164-0898, US

(21) Appl. No.: 11/726,907

(22) Filed: Mar. 23, 2007

Related U.S. Application Data
(63) Continuation-in-part of application No. 11/520,459, filed on Sep. 13, 2006.

(51) Int. Cl. G08B 13/14

(52) U.S. Cl. 340/572.1

(57) ABSTRACT

An electronic data storage device tracing system includes at least one data storage device and a reader system. The data storage device includes a housing having an optical label and a device RFID tag coupled to the housing. In this regard, the optical label is printed with a VOLSER number and the device RFID tag includes a chip that electronically stores the VOLSER number. The reader system is configured to read the VOLSER number from the chip and trace the at least one data storage device entering/exiting the reader system.

### CROSS REFERENCE TO RELATED APPLICATION

This Utility patent application is related to commonly assigned and concurrently filed Utility patent application Ser. No. ______, entitled TRACEABLE RFID ENABLED DATA STORAGE DEVICE having Attorney Docket Number 10582US03, and claims the benefit of the filing date under 35 U.S.C. § 120 as a continuation-in-part of prior filed application U.S. application Ser. No. 11/520,459, filed Sep. 13, 2006, entitled “SYSTEM AND METHOD FOR TRACING DATA STORAGE DEVICES,” both of which are incorporated herein by reference in their entirety.

### BACKGROUND

Data storage devices have been used for decades in computer, audio, and video fields for storing large volumes of information for subsequent retrieval and use. Data storage devices continue to be a popular choice for backing up data and systems.

Data storage devices include data storage tape cartridges, hard disk drives, micro disk drives, business card drives, and removable memory storage devices in general. These data storage devices are useful for storing data and for backing up data systems used by businesses and government entities. For example, businesses routinely backup important information such as human resource data, employment data, compliance audits, and safety/inspection data. Government sources collect and store vast amounts of data related to tax payer identification numbers, income withholding statements, and audit information. Congress has provided additional motivation for many publicly traded companies to ensure the safe retention of data and records related to government required audits and reviews after passage of the Sarbanes-Oxley Act (Pub. L. 107-204, 116 Stat. 745 (2002)).

Collecting and storing data has now become a routine business practice. In this regard, the data can be generated in various formats by a company or other entity, and a backup or backups of the same data is often saved to one or more data storage devices that is/are typically shipped or transferred to an offsite repository for safe/secure storage. Occasionally, the backup data storage devices are retrieved from the offsite repository for review and/or updating. With this in mind, the transit of data storage devices between various facilities introduces a possible risk of loss or theft of the devices and the data stored that is stored on the devices.

Users of data storage devices have come to recognize a need to safely store, retain, and retrieve the devices. For example, backing up data systems can occur on a daily basis. Compliance audits and other inspections can require that previously stored data be produced on an “as-requested” basis. With this in mind, it is both desirable and necessary for a user of data storage devices to be able to identify what data is stored on which device, and to locate where a specific device is. To complicate the general matter of identifying one device from another, the consumer often chooses to identify their “used” data storage devices by some form of a familiar or user-generated consumer number, which can be a non-unique number. Thus, tracking the data stored and tracing where the device is located is a challenging task.

The issue of physical data security and provenance is a growing concern for users of data storage devices. Thus, manufacturers and users both are interested in systems and/or processes that enable tracing and tracking of data storage devices. Improvements to the tracing and ability to immediately locate data storage devices used to store vital business data is needed by a wide segment of both the public and private business sector.

### SUMMARY

One aspect of the present invention provides an electronic data storage device tracing system. The tracing system includes at least one data storage device and a reader system. The data storage device includes a housing having an optical label and a device radio frequency identification (RFID) tag coupled to the housing. In this regard, the optical label is printed with a VOLSER number and the device RFID tag includes a chip that electronically stores the VOLSER number. The reader system is configured to read the VOLSER number from the chip and trace the data storage device(s) entering/exiting the reader system.

Another aspect of the present invention provides an electronic data storage device tracing system. The electronic data storage device tracing system includes means for instantaneously reading VOLSER data for a plurality of data storage devices, means for compiling a report related to the VOLSER data, and means for tracing the plurality of data storage devices based upon the compiled report.

Another aspect provides an electronic data storage device tracing system that includes at least one data storage device and a reader system. The data storage device(s) include a housing providing device data and an RFID tag coupled to the housing, where the RFID tag includes an electronically stored identification number. The reader system includes a user interface in communication with a reader unit, the user interface including a database, the reader unit configured to read the identification number from the RFID tag, and the user interface configured to append the read identification number to the database. In this regard, the user interface is operable to associate the identification number of the RFID tag to a specific one of the at least one data storage device according to the device data and configured to trace each data storage device in transit relative to the reader system.

Another aspect provides a method of tracing data storage devices entering/exiting a location. The method includes staging at least one data storage device at a reader system upon arrival/departure of the data storage device(s) at the location, and radio frequency reading an identification of each data storage device with a reader unit of the reader system. The method additionally provides tracing transit of each data storage device relative to the reader system.

Another aspect provides an RFID enabled data storage device configured to be traced by an electronic data storage device tracing system. The data storage device includes a housing defining an enclosure, data storage media disposed within the enclosure, a label coupled to the housing, and an RFID tag coupled to the housing. The label includes a VOLSER number configured to identify the contents of the data storage media, and the RFID tag is programmed with a unique identification number and at least the label VOLSER number. In this regard, the label and the RFID tag combine to uniquely identify an in-transit data storage device to the system.

Another aspect provides a kit of parts configured to enable a system to track a data storage cartridge. The kit of parts includes an RFID tag configured for attachment to a housing of the data storage cartridge, and a label including device data configured for attachment to the housing of the data storage cartridge. The RFIG tag is programmed with a unique identification number. In this regard, the RFID tag is configured to be initialized with the device data such that the RFID tag and the label combine when attached to the housing to uniquely identify the data storage device to the system.

Another aspect provides a tracing system configured to trace a container of data storage devices. The tracing system includes an antenna in communication with a reader unit and a user interface in communication with the reader unit. The antenna/reader unit being configured to radio frequency read an identification number from an RFID tag coupled to the container identifying the container and its contents. The user interface including a database, the user interface configured to append the read identification number to the database. In this regard, the user interface is operable to associate the identification number of the RFID tag with the container, and configured to trace the container in transit relative to the reader system based upon information appended to the database.

### BRIEF DESCRIPTION OF THE DRAWINGS

Embodiments of the invention are better understood with reference to the following drawings. The elements of the drawings are not necessarily to scale relative to each other. Like reference numerals designate corresponding similar parts.

FIG. 1 illustrates a perspective view of an electronic data storage device tracing system according to one embodiment of the present invention;

FIG. 2 illustrates a perspective, exploded view of a data storage device including an optical label and a device RFID tag according to one embodiment of the present invention;

FIG. 3A illustrates a top view of a device RFID tag according to one embodiment of the present invention;

FIG. 3B illustrates a top view of a device RFID tag according to another embodiment of the present invention;

FIG. 3C illustrates a side view of a label including the device RFID tag illustrated in FIG. 3A;

FIG. 4A illustrates a cross-sectional view of a portion of a housing of the data storage device illustrated in FIG. 2 including the device RFID tag attached to an interior surface of the housing;

FIG. 4B illustrates a cross-sectional view of a portion of the housing of the data storage device illustrated in FIG. 2 including a device RFID tag attached to an exterior surface of the housing;

FIG. 5A illustrates a micro hard drive data storage device according to one embodiment of the present invention;

FIG. 5B illustrates a micro hard drive data storage device according to another embodiment of the present invention;

FIG. 6 illustrates a cross-sectional view of a pad antenna of the tracing system illustrated in FIG. 1;

FIG. 7 illustrates a planar view of a program operable by a graphical user interface of the tracing system illustrated in FIG. 1;

FIG. 8 illustrates another planar view of the program illustrated in FIG. 7;

FIG. 9 illustrates another planar view of the program illustrated in FIG. 7;

FIG. 10 illustrates another planar view of the program illustrated in FIG. 7;

FIG. 11A illustrates multiple data storage devices disposed within a case that is positioned proximate to a reader system of the tracing system illustrated in FIG. 1 in accordance with one embodiment of the present invention;

FIG. 11B illustrates a front view of a handheld portable reader device of the reader system illustrated in FIG. 11A;

FIG. 11C illustrates a top view of the case on the reader system illustrated in FIG. 11A;

FIG. 12 illustrates an exploded, perspective view of the case illustrated in FIG. 1A including a cover insert according to one embodiment of the present invention;

FIG. 13A illustrates a cross-sectional view of an insert lock according to one embodiment of the present invention;

FIG. 13B illustrates a cross-sectional view of an insert lock according to another embodiment of the present invention;

FIG. 13C illustrates a cross-sectional view of an insert lock including a retainer assembly according to another embodiment of the present invention;

FIG. 14A illustrates a perspective, exploded view of a case and an insert system configured to retain multiple data storage devices according to one embodiment of the present invention;

FIG. 14B illustrates a side view of multiple data storage devices retained by a base insert of the insert system illustrated in FIG. 14A;

FIG. 15 illustrates a cross-sectional view of the insert system of FIG. 14A retained within the case;

FIG. 16 illustrates a perspective view of a label printer including a label scanner and an RFID reader according to one embodiment of the present invention;

FIG. 17 illustrates a reader system including a U-shaped antenna assembly according to one embodiment of the present invention;

FIG. 18 illustrates a reader system including an adjustable antenna assembly according to one embodiment of the present invention;

FIG. 19A illustrates a reader system including a flip antenna assembly according to one embodiment of the present invention;

FIG. 19B illustrates two antenna panels of the flip antenna assembly shown in FIG. 19A deployed orthogonally;

FIG. 20 illustrates a reader system including a portable antenna assembly according to one embodiment of the present invention;

FIG. 21 illustrates a flow chart of a process for tracing one or more data storage devices in transit according to one embodiment of the present invention;

FIG. 22 illustrates an electronic data storage device tracing system according to another embodiment;

FIG. 23 illustrates a simplified diagrammatical view of another electronic data storage device tracing system according to one embodiment;

FIG. 24 illustrates a screen shot of a user interface of the system illustrated in FIG. 23;

FIG. 25A illustrates a perspective view of a label replacement workflow station according to one embodiment;

FIG. 25B illustrates a perspective view of the workflow station shown in FIG. 25A including a cartridge updated an RFID enabled label;

FIG. 26 illustrates a screen shot of a user interface of the workflow station shown in FIG. 25A;

FIG. 27A illustrates a perspective view of a VOLSER RFID label initialization station according to one embodiment;

FIG. 27B illustrates another perspective view of the label initialization station shown in FIG. 27A;

FIG. 28 illustrates a screen shot of a user interface communicating with the label initialization station shown in FIG. 27B;

FIG. 29 illustrates a diagrammatic view of a reader system RFID antenna according to one embodiment;

FIG. 30A illustrates a perspective view of an electronic data storage device tracing system including a reader system having a pressure-sensing automated scan switch according to one embodiment;

FIG. 30B illustrates a perspective view of an electronic data storage device tracing system including a reader system having a foot switch configured to initiate an RFID scan according to one embodiment; and

FIG. 31 illustrates a kit of parts including an RFID tag and a VOLSER label contained in a package according to one embodiment.

### DETAILED DESCRIPTION

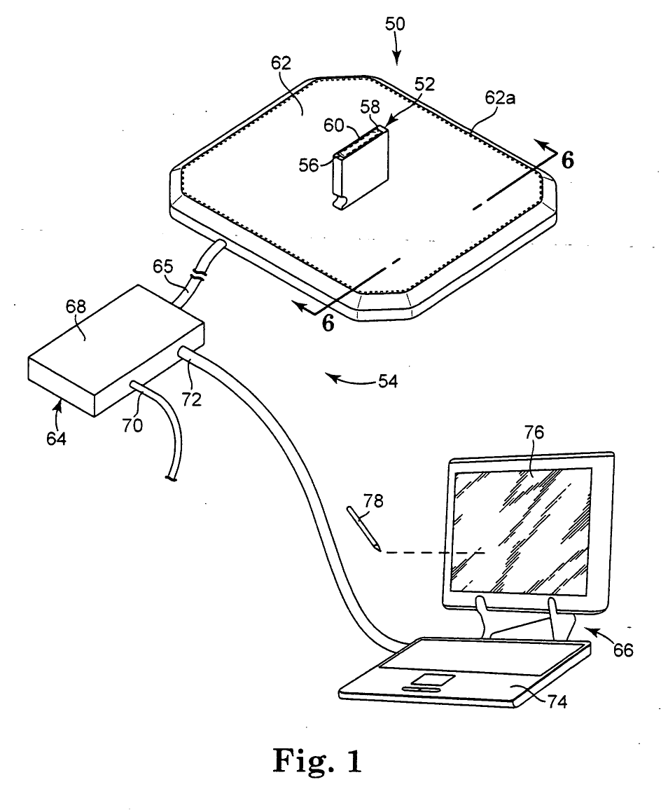

FIG. 1 illustrates a perspective view of an electronic data storage device tracing system 50 according to one embodiment of the present invention. The tracing system 50 includes a data storage device 52 and a reader system 54 configured to trace the data storage device 52 as it enters and leaves a facility, for example. In particular, in one embodiment the data storage device 52 includes a housing 56 having an optical label 58 and a device radio frequency identification (RFID) tag 60 coupled to the housing 56. The optical label 58 is printed with multiple data fields, including at least one specific data field related to a VOLSER number for the data storage device 52, as described in detail below.

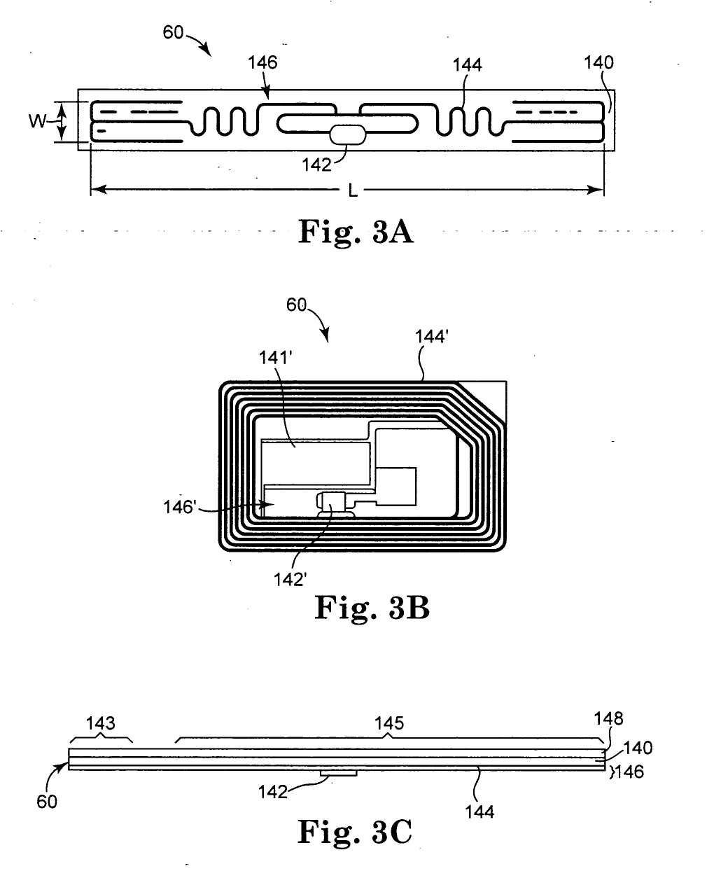

The device RFID tag 60 includes an electronic chip (See FIG. 3A) that is configured to electronically store multiple fields of data, including an electronic VOLSER number that corresponds to the VOLSER number that is printed on the optical label 58. In this manner, the VOLSER number that is printed on the optical label 58 is readable by any number of optical reading systems, including electronic optical reading systems and users looking at the optical label 58. The reader system 54 is configured to electronically read the VOLSER number from the device RFID tag 60 and create a record including at least a time at which the data storage device 52 is proximate the reader system 54. In this manner, the data storage device 52 is traced as it exits or enters a facility.

In one embodiment, the reader system 54 includes an antenna pad 62 having a pad antenna 62a (or antenna 62a) operably coupled to a reader unit 64 via a cable 65 and electrically coupled to a graphical user interface (GUI) 66. In one embodiment, the antenna pad 62 includes an impedance matching network (not shown, but internal to the pad 62) between the antenna 62a and the cable 65. In general, the pad antenna 62a is configured to generate an electromagnetic field that inductively powers the device RFID tag 60. The pad antenna 62a is sized/selected based upon balancing certain radiation limits that government entities place on such antennas with a desired/specified range for the pad antenna 62a in activating the device RFID tag 60, and with a convenient pad size. For example, the Federal Communications Commission (FCC) specifies a field limit for antenna output at 10 meters and 30 meters, and the pad antenna 62a is sized as described below to provide a read range for at least one data storage device 52, and preferably for multiple data storage devices 52, that complies with the FCC field limits. With this in mind, one embodiment of the pad antenna 62a provides a rectangular antenna 62a having an effective antenna area of about 370 mm by about 450 mm to provide a sufficient read field out to a furthermost edge of multiple data storage devices 52 that are placed adjacent to the pad antenna 62, as more fully described in FIG. 6

The reader unit 64 includes an enclosure 68 housing a transceiver, signal processor, controller, memory, power supply, and reader PC board (not shown) that are operable to read data from the device RFID tag 60 and transmit the data to the GUI 66. In this regard, in one embodiment the reader unit 64 is generally a transceiver and includes reader software having a library of calls and a source code that enables the contactless identification of objects. One example of suitable reader software includes software provided with a Feig Electronics RFID reader unit available from Feig Electronics, Weilburg, Germany. These and other suitable reader units are compatible and comply with ISO, EN, DIN standards. In general, the reader unit 64 is powered by an electrical connection 70, such as a 120 volt power cord, and includes an output connection 72, such as an Ethernet connection or a universal serial bus (USB) that couples to the GUI 66. Other power sources and output connectors are also acceptable.

The cable 65 is selected to have a length that desirably separates the reader unit 64 from the pad antenna 62a to minimize possible interference between the reader unit 64 and the antenna 62a. In an alternative embodiment, the reader unit 64 is integrated with the pad antenna 62a and the cable 65 is optional.

In one embodiment, the GUI 66 includes a memory unit 74 and a display unit 76. The data collected from the data storage device 52 by the reader unit 64 can be transmitted to the GUI 66 for data storage, data manipulation, and data appending in a variety of manners. For example, in one embodiment the GUI 66 records and sorts data collected from multiple such data storage devices 52 passing by the reader system 54. In another embodiment, the GUI 66 is operable to append data to the device RFID tag 60, including a VOLSER number that might either be missing from the data storage device 52 or not yet initialized to the data storage device 52. In other embodiments, the GUI 66 is operable to append and record shipping information related to the transfer of the data storage device 52 as it leaves a user facility in transit to a storage facility, or as the data storage device 52 returns from a storage facility to the user facility.

In general, the GUI 66 operates on GUI software that is adapted to access the library of calls and the source code of the software of the reader unit 64 described above. In particular, in one embodiment the GUI software employs a code that communicates with the software of the reader unit 64 and enables a user of the GUI 66 to generate encrypted tag ID numbers and/or cyclic redundancy check values that are stored in the device RFID tag 60, as described in FIG. 3A below. With this in mind, in one embodiment the reader system 54 employs the software of the reader unit 64 to determine the identification of the device RFID tags 60 that are within range of the field generated by the pad antenna 62, and the GUI software is employed to read information, including encrypted information, between the device RFID tag 60 and the GUI 66.

For example, software of the reader unit 64 is employed to read information from the device RFID tag 60, and software of the GUI 66 accesses the information read by the software of the reader unit 64 and writes a file in extensible markup language (XML). The XML file is executed in a form that enables a user to customize the definition, transmission, validation, and/or interpretation of data within fields of the device RFID tag 60. The XML file is configured for sharing with a database via software operable by the GUI 66. In this manner, a user of the system 50 experiences seamless file sharing between the database software and the software of the GUI 66, which is useful in the tracing of the data storage device 52 via the device RFID tag 60. In one embodiment, the database software is a tape management software useful in collating information related to the shipment of data storage devices, for example, and the software of the GUI 66 is dynamically linked via an operating system of the GUI 66 to communicate with the tape management software, such that little or no user intervention is necessitated in the tracing of devices 52 via the system 50. In one embodiment, the XML file generated by the software of the GUI 66 is encrypted such that the definition, transmission, validation, and/or interpretation of data between the software of the GUI 66 and the database are secure.

The storing, sorting, and appending of data by the GUI 66 can include the user manipulation of a stylus 78 that interacts with the display unit 76. In this regard, the GUI 66 enables a user to view the data storage devices 52 that are traced, and view and manipulate the corresponding VOLSER numbers of the data storage devices 52 that are sorted and traced between facilities. For example, in one embodiment the user employs the stylus 78 to select, sort, and input a desired disposition (destination or receipt location) of one or more devices 52 into display unit 76, the selection of which is stored and/or operated on by the memory unit 74 as assisted by the GUI software and ultimately communicated to a lookup/tracing database, for example via transmission over the Internet.

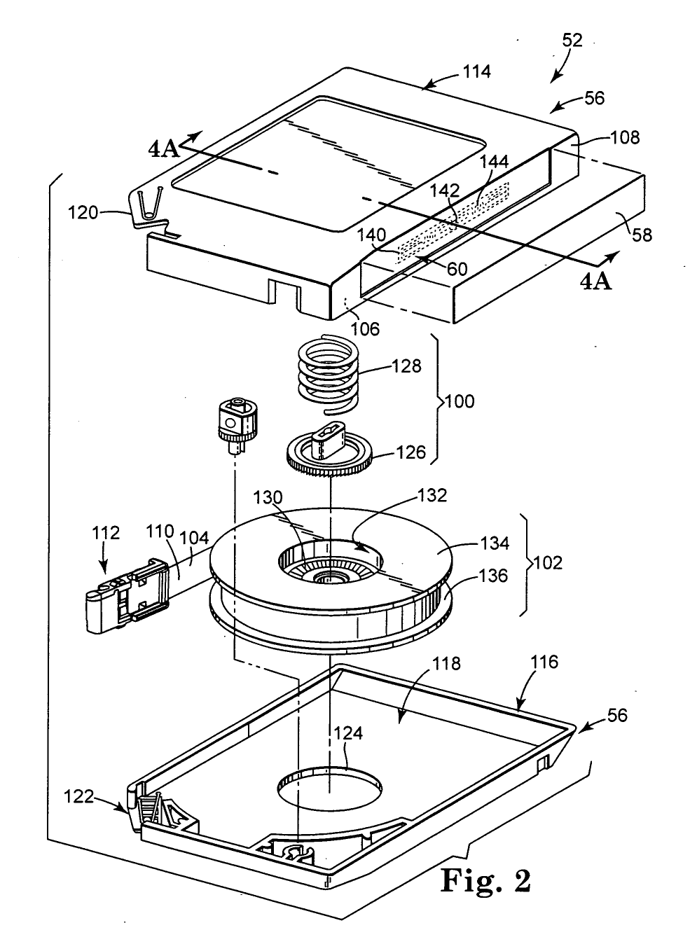

FIG. 2 illustrates an exploded view of the data storage device 52 according to one embodiment of the present invention. The data storage device 52 is illustrated as a single reel data storage tape cartridge, although it is to be understood that other forms of data storage devices are also acceptable, including data storage devices such as a micro hard drive, a hard disk drive, a quarter-inch cartridge, and scaleable linear recording cartridges to name but a few examples. Thus, the present invention is usefully employed with a variety of data storage devices, and the data storage device 52 illustrated is but one example.

Generally, the data storage device 52 includes the housing 56, a brake assembly 100, a tape reel assembly 102, and a storage tape 104. In one embodiment, the device RFID tag 60 is coupled to an interior surface 106 of the housing 56, and the optical label 58 is coupled to an exterior surface 108 of the housing 56. In this regard, although the optical label 58 is illustrated as coupled to a side of the housing 56, it is to be understood that the optical label 58 is coupleable to other portions of the exterior surface 108 of the housing 56, such as an end surface, for example. The tape reel assembly 102 is disposed within the housing 56. The storage tape 104, in turn, is wound about the tape reel assembly 102 and includes a leading end 110 attached to a leader block 112.

The housing 56 is sized for insertion into a typical tape drive (not shown). Thus, the housing 56 size is approximately 125 mm×110 mm×21 mm (having a volume of about 29 cm³), although other dimensions are equally acceptable. With this in mind, the housing 56 defines a first housing section 114 and a second housing section 116. In one embodiment, the first housing section 114 forms a cover, and the second housing section 116 forms a base. It is to be understood that directional terminology such as “cover,” “base,” “upper,” “lower,” “top,” “bottom,” etc., is employed throughout this specification to illustrate various examples, and is in no way intended to be limiting.

The first and second housing sections 114 and 116, respectively, are reciprocally mated to one another to form an enclosed region 118 and are generally rectangular, except for one corner 120 that is preferably angled to form a tape access window 122. The tape access window 122 forms an opening for the storage tape 104 to exit the housing 56 when the leader block 112 is removed from the tape access window 122 and threaded to a tape drive system (not shown) for read/write operations. Conversely, when the leader block 112 is stored in the tape access window 122, the tape access window 122 is covered.

In addition to forming a portion of the tape access window 122, the second housing section 116 also forms a central opening 124. The central opening 124 facilitates access to the tape reel assembly 102 by a drive chuck of the tape drive (neither shown). During use, the drive chuck enters the central opening 124 to disengage the brake assembly 100 prior to rotating the tape reel assembly 102 for access to the storage tape 104.

The brake assembly 100 is of a type known in the art and generally includes a brake body 126 and a spring 128 co-axially disposed within the tape reel assembly 102. When the data storage device 52 is idle, the brake assembly 100 is engaged with a brake interface 130 to selectively “lock” the tape reel assembly 102 to the housing 56.

The tape reel assembly 102 includes a hub 132, an upper flange 134, and a lower flange 136. The hub 132 defines a tape-winding surface (not visible in FIG. 2 due to the presence of the storage tape 104) about which the storage tape 104 is wound. The flanges 134, 136 are optional. For example, in one embodiment the storage tape 104 is wound about a flangeless hub such that the tape reel assembly 102 comprises only the flangeless hub. When the flanges 134, 136 are provided, they are coupled to opposing ends of the hub 132 and extend in a radial direction from the hub 132. It is desired that the flanges 134, 136 be spaced a distance apart that is slightly greater than a width of the storage tape 104. In this manner, the flanges 134, 136 are adapted to guide and collate the storage tape 104 as it is wound onto the hub 132.

The storage tape 104 is preferably a magnetic tape of a type commonly known in the art. For example, the storage tape 104 can be a balanced polyethylene naphthalate (PEN) based substrate or polyester substrate coated on one side with a layer of magnetic material dispersed within a suitable binder system, and coated on the other side with a conductive material dispersed within a suitable binder system. Acceptable magnetic tape is available, for example, from Imation Corp., of Oakdale, Minn.

The leader block 112 covers the tape access window 122 during storage of the data storage device 52 and facilitates retrieval of the storage tape 104 for read/write operations. In general terms, the leader block 112 is shaped to conform to the window 122 of the housing 56 and to cooperate with the tape drive (not shown) by providing a grasping surface for the tape drive to manipulate in delivering the storage tape 104 to the read/write head. In this regard, the leader block 112 can be replaced by other components, such as a dumb-bell shaped pin. Moreover, the leader block 112, or a similar component, can be eliminated entirely, as is the case with dual reel cartridge designs.

In one embodiment, a first pocket (not shown) is formed in the first housing section 114 and a second reciprocal and opposing pocket (not shown) is formed in the second housing section 116 such that upon assembly of the housing 56, the opposing pockets combine to form a cavity within the enclosed region 118 that is configured to retain the device RFID tag 60. In this regard, the device RFID tag 60 is coupled to the housing 56 by being retained within the cavity. In another embodiment, the device RFID tag 60 is adhesively attached directly to the interior surface 106 of the first housing section 114.

In one embodiment the device RFID tag 60 is a passive RFID tag and includes a backing 140, a silicon chip 142, and an antenna 144. The backing 140 is a substrate configured to retain the silicon chip 142 and the antenna 144. In this regard, the backing 140 is a carrier for the chip 142 and the antenna 144 components and in one embodiment is rigid and is referred to as a printed circuit board backing. For example, in one embodiment the backing 140 is a polyester backing to which two or more layers of a metal foil are adhered. The metal foils are etched to form a coiled antenna 144, a capacitor, and integrated circuit (IC) pads. Suitable connections are made between the foil layers, and an integrated circuit such as the chip 142 is attached and electrically connected to the IC pads employing, for example, an anisotropic conductive adhesive.

In an alternate embodiment, the backing 140 is a flexible film backing onto which the chip 142 and the antenna 144 components are laminated to one side prior to adhesively attaching an opposing side of the backing 140 to the interior surface 106 of housing 56. In addition, the backing 140 can include electrical features (such as pads, metal-plating holes, wire bonding, etc.) adapted to facilitate information transfer to/from the chip 142. In any regard, it is generally desirable to locate the antenna 144 relative to the housing 56 (FIG. 2) away from large metal components (such as baseplates) and equipment interference points to minimize mechanical and electrical interference of the device RFID tag 60 during read/write and handling of the device 52.

FIG. 3A illustrates a top view of one embodiment of the device RFID tag 60. The device RFID tag 60 includes circuitry 146 including the chip 142 and the antenna 144 printed on the backing 140. In one embodiment, the RFID tag 60 is an EPC class 1 RFID tag configured to be programmed and/or read by GUI software that is operated by the reader system 54 (FIG. 1). In a preferred embodiment, multiple RFID tags 60 can be individually and simultaneously identified (read or electrically recognized) by the reader system 54. In one embodiment, the RFID tag 60 is an ultra high frequency (UHF) tag. Other forms of the RFID tag 60 are also acceptable, such as high frequency (HF) tags.

FIG. 3B illustrates a top view of another embodiment of the device RFID tag 60. The device RFID tag 60 is a high frequency HF 13.56 MHz tag that includes circuitry 146′ having a capacitor 141′, a chip 142′ and an antenna 144′ printed on a backing 140′. One suitable HF tag is a 13.56 MHz ISO 15693 “vicinity” tag.

As a point of reference, when the device RFID tag 60 is a passive RFID tag, it does not employ its own power source. In this regard, the passive RFID tag is “powered” whenever access to the tag is initiated by the reader system 54 (FIG. 1). For example, when the reader unit 54 queries the RFID tag, an alternating current in the antenna pad 62 (FIG. 1) induces a current in the antenna 144 of the passive RFID tag. This magnetically induced current in the RFID tag enables the tag to send and/or receive data. With this in mind, in one embodiment the device RFID tag 60 is a passive RFID tag having a practical read range of less than approximately 6 feet (about 2 meters). The passive RFID tag preferably responds to a field less than 1 A/m. It preferably has a resonant frequency near 13.56 MHz when placed on the data storage device. To this end, in one embodiment the silicon chip 142 is a radio frequency memory chip and includes a radio frequency interface (not shown) to support a nearby, contactless access to/from the memory.

FIG. 3C illustrates a side view of the device RFID tag 60 of FIG. 3A according to one embodiment of the present invention. The circuitry 146 is generally printed or wired or disposed on the backing 140. In one embodiment, the silicon chip 142 projects out of the circuitry 146 and away from the backing 140 to define a prominence that is accommodated by a relief area of the first housing section 114, described below. In another embodiment, the chip 142 is disposed between the circuitry 146 and an optical label 148 that is placed over the circuitry 146. In another embodiment, the chip 142 is covered by a protective layer, such as a thin plastic sheet or a drop of encapsulant, to increase its resistance to physical or chemical damage.

In one embodiment, the device RFID tag 60 includes an optical label 148 coupled to the backing 140 opposite of the circuitry 146. The label 146 provides a continuous lateral area that is suited for printing a media identification field 143 alongside of a VOLSER identification field 145. In this regard, in one embodiment the label 148 is a newly manufactured label that is printed with the media identification field 143 and the VOLSER identification field 145 and is attached over the circuitry 146 of a new device RFID tag 60 during the manufacture of a new data storage device 52. In another embodiment, the label 148 is optional and the media identification field and the VOLSER identification field are provided as a portion of a retrofitted optical label 58 (FIG. 2) that can be directly attached to the device RFID tag 60 or attached to the first housing section 114 in a region near the device RFID tag 60.

The RFID tag 60 includes the backing 140 or other substrate onto which is disposed circuitry 146 including the capacitor 141′, the silicon chip 142 and the antenna 144. In this regard, the circuitry 146, which includes the chip 142 and the antenna 144, is referred to as an inlay (or inlet) 146. In one embodiment, the backing 140 is a laminate having adhesive coated onto each of the opposing two sides. One adhesively coated side is configured for attachment to the housing 56 (FIG. 2), and the opposing adhesively coated side is suited for receiving the inlay 146. Other suitable forms for the backing 140 are also acceptable. When a printed label is attached over the inlay 146, the resulting structure is referred to as an RFID label.

The silicon chip 142 electronically records and/or stores device information and is not necessarily drawn to scale in FIGS. 2 and 3A-3C. In one embodiment, the silicon chip 142 is configured to store device information into a plurality of data fields. For example, in one embodiment, the silicon chip 142 is a memory chip capable of recording and/or storing device information, such as a format of data stored on the device 52 and a VOLSER number associated with the device 52. In one embodiment, the memory of the silicon chip 142 stores a subset of data that is present on the optical label 58. In an alternative embodiment, the memory of the silicon chip 142 stores all data that is present on the optical label 58 and includes fields including a 64 bit unique TAG identifier, an 8 bit RFID revision level, an 88 bit user defined VOLSER number, a 32 bit cyclic redundancy check (CRC) sum, a 160 bit manufacturer's serial number, a case and/or device identifying number, and other data fields. In another embodiment, the silicon chip 142 stores different field information for different forms of devices 52. To this end, the silicon chip 142 is preferably an electronic memory chip having at least the memory capacity to be written with device information. In one embodiment, the silicon chip 142 is an electronic memory chip capable of retaining stored data even in a power “off” condition, and is for example, a 4 k-byte electrically erasable programmable read-only memory (EEPROM) chip known as an EEPROM chip available from, for example, Philips Semiconductors, Eindhoven, The Netherlands. In another embodiment, the silicon chip 142 is a 1 k-byte EEPROM chip. Those with skill in the art of memory chips will recognize that other memory formats and sizes for the chip 142 are also acceptable.

The chip 142 is programmed to have a specific content and format for the information stored in memory. In one embodiment, the chip 142 electronically stores a subset of the data present on the optical label 58 (FIG. 2), such as the format of the device 52 and the VOLSER number. In another embodiment, the chip 142 electronically stores multiple subsets of data including the 8 bit RFID revision field, the 88 bit user defined VOLSER number, the 32 bit CRC sum that is derived from the tag ID and the RFID revision and the user defined VOLSER number, an optional 160 bit manufacturer's serial number, and one or more optional user defined fields that enables selective user expansion of the data fields over time. In one embodiment, the 64 bit tag ID is pre-programmed by the chip manufacturer. In one embodiment, the RFID revision field specifies a revision level of the data stored on the chip 142, and also determines the format of the information that is read sequentially.

In one embodiment, the VOLSER number is a unique number that is specific to each data storage device it is associated with. In another embodiment, the VOLSER number is a non-unique number. The VOLSER number can be user-defined or assigned by a manufacturer according to specifications provided by a customer. In general, the VOLSER number includes a character within the 88 bit field to mark the end of the VOLSER number, which enables the reading and interpretation of variable length and/or unique VOLSER numbers. In one embodiment, the end mark character is a NULL character, for example 8 bits of all binary zeros. As a point of reference, 8 bits of all binary zeros is the initial state of the memory, and also corresponds with a string termination character in the program language C/C++. In one embodiment, the bit pattern of the VOLSER number is not encrypted when reading or writing the VOLSER number to enable easy decoding by an outside source, such as a customer or client. In other embodiments, the VOLSER number is encrypted (for example by inverting the bits) to prevent decoding by an outside source, or encoded to save space in the memory of the chip 142.

The CRC is a 32 bit field derived from the tag ID, the RFID revision, and the VOLSER number. In one embodiment, the CRC is form of a hash function that is employed to produce a check value against a block of data, such as a packet of network traffic or a block of a computer file. In this regard, a check value is a small, fixed number of bits that can be employed to detect errors after transmission or storage of data. For example, in one embodiment the CRC is computed and appended before transmission or storage, and verified afterwards by a recipient to confirm that no changes occurred on transmission of the data. Advantages of CRCs are that they are easily implemented in binary hardware, they can be analyzed mathematically, and CRCs detect common errors caused by noise in transmission channels.

The CRC value is the remainder of a binary division that has no bit carry in the message bit stream, by a pre-defined and preferably short bit stream having a length n, where n represents a coefficient of a polynomial. Generally, CRCs are derived from the division of a polynomial, such as a ring of polynomial, over a finite field. In this regard, the set of polynomials is chosen such that each coefficient is either 0 or 1 (which is a fundamental of a binary or base 2 number). In an exemplary embodiment, the generating polynomial of the CRC is chosen to be:

x̂32+x̂26+x̂23+x̂22+x̂16+x̂12+x̂11+x̂10+x̂8+x̂7+x̂5+x̂4+x̂2+x̂1+x̂0

and a seed value is selected to be 0xFFFFFFFF. In this manner, the CRC enables the determination if one or more of the tag ID, the RFID revision, or the VOLSER number have become corrupted or incorrectly read during transmission.

In other embodiments, a checksum, parity check, or other function may be employed to generate the check value for the data. A checksum usually refers to a check value that is a sum of the data being checked. A parity check usually refers to a check value that is the exclusive-or of the data being checked. The set of functions useful in generating such check values are referred to as hash functions.

In one embodiment, the antenna 144 is a coiled copper radio frequency (RF) antenna. In an alternate embodiment, the antenna 144 is integrated within the chip 142. In any regard, it is to be understood that other materials for, and various forms of, the antenna 144 are also acceptable. In general, the antenna 144 is configured to inductively couple with the reader system 54 (FIG. 1) in receiving/sending data. With this in mind, in one embodiment the antenna 144 is an RF antenna configured to communicate information stored on the chip 142 to a transceiver module (not shown) in the reader unit 64 (FIG. 1).

In one embodiment, the device RFID tag 60 is employed in a 13.56 MHz RFID system and the antenna 144 has a reactance that produces a resonance of about 13.56 MHz. In this regard, for RFID circuits having a capacitance of 27 pF, the antenna coil and parallel capacitor have a reactance of about +j435 ohms, equivalent to an inductance of about 5.1 μH. Other IC capacitances require different antenna reactances to resonate at 13.56 MHz. To this end, other capacitances and antenna reactances for the device RFID tag 60 are also acceptable. In one embodiment, the antenna 144 has a capacitance that is adjustable to tune the resonant frequency. In another embodiment, the capacitance of the antenna 144 is laser trimmed.

It is desired that the device RFID tag 60 be sized to fit within a perimeter of the optical label 58 (FIG. 2), and be sized to have an appropriate range for the antenna pads 62 (FIG. 1). In this regard, in one embodiment the circuitry 146 is optimally sized to be disposed within a boundary of the backing 140, and defines a width of W and a length L that approximates a perimeter of the antenna 144. The circuitry width W and the circuitry length L are sized and selected according to the size of the data storage device to which they are attached. With this in mind, an exemplary width W is between about 5 mm-20 mm, and an exemplary length L is between about 50 mm-100 mm. One of skill in the art will recognize that the width W and the length L for the circuitry 146, and thus the antenna 144, is adjustable in order to provide a suitable read range between the system 50 (FIG. 1) and the device RFID tag 60. For coiled antennas used in high frequency tags, the larger the area of the coil the larger the potential read range.

For example, one aspect of the invention provides the data storage device 52 as a data storage tape cartridge and the antenna 144 within the circuitry 146 is selected to have a width W of about 15 mm and a length L of about 77 mm, resulting in an antenna area of about 1155 sq. mm. In this manner, the antenna 144 is provided with a sufficient range, while the device RFID tag 60 is sized to fit beneath the optical label 58 (FIG. 2). In another exemplary embodiment, the antenna 144 is sized to have a width W of about 15 mm and a length L of about 62 mm, resulting in an antenna area of about 930 sq. mm. In other embodiments, the antenna 144 is sized to have a width W of about 8.8 mm and a length L of about 70 mm and has an antenna area of about 616 sq. mm, which is suited for attachment to devices having slim profiles. In yet another embodiment, the antenna 144 is sized to have a width W of about 15 mm and a length L of about 77 mm. The antenna dimensions set forth above are exemplary dimensions, as other antenna dimensions are also acceptable. Generally, the width W and the length L of the circuitry 146 are sized such that the antenna 144 is about 1 mm less in width and about 2 mm less in length in comparison to dimensions of the smallest backing 140 and label that is sized to cover the backing 140.

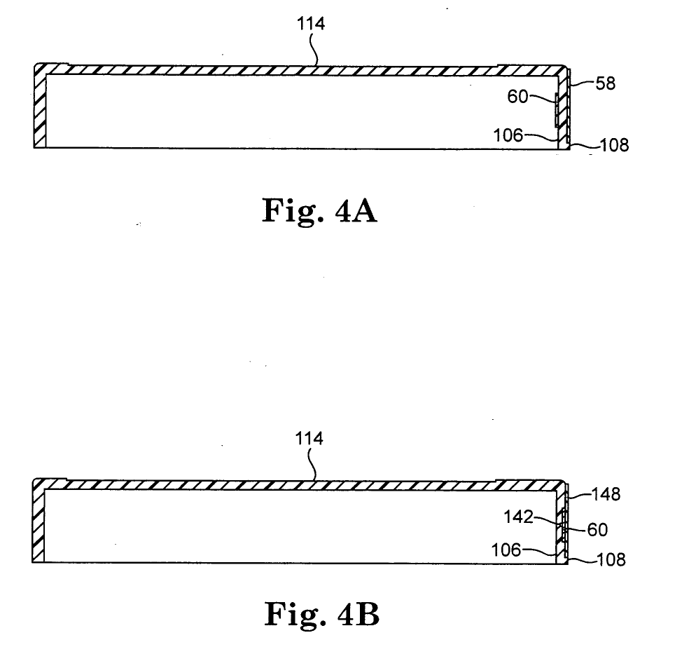

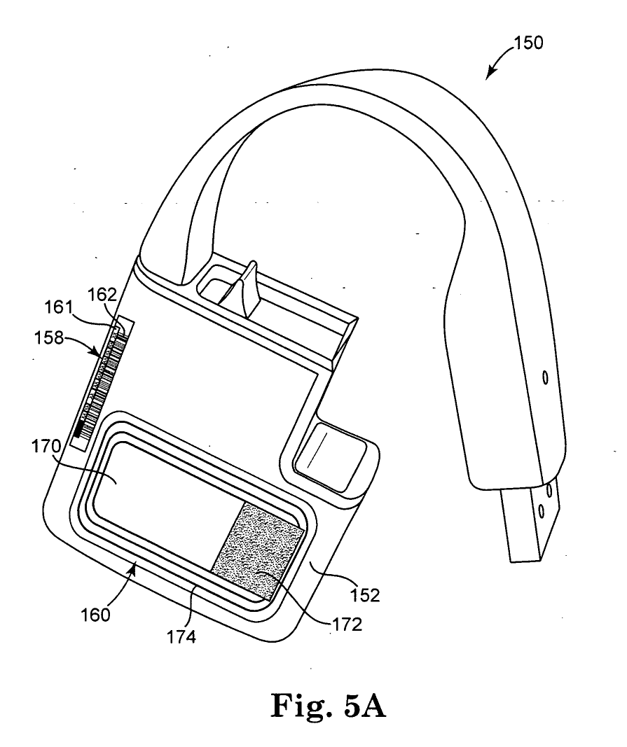

FIG. 4A illustrates a cross-sectional view of the first housing section 114 showing one configuration for locating the device RFID tag 60 relative to the first housing section 114. In one embodiment, the data storage device 52 (FIG. 2) is newly manufactured to include the device RFID tag 60 on the interior surface 106 of the first housing section 114, and the optical label 58 is secured to the exterior surface 108 of the first housing section 114. In this manner, the device RFID tag 60 is located inside of the first housing section 114, and thus located away from potential wear and handling points present on the exterior surface 108 of the first housing section 114. During a manufacturing step, the device RFID tag 60 is programmed to include at least a subset of the data that is printed on the optical label 58. In particular, the device RFID tag 60 is preferably electronically programmed to include at least the VOLSER data that is printed on the optical label 58.

FIG. 4B illustrates a cross-sectional view of the first housing section 114 showing another “retrofit” configuration for locating the device RFID tag 60 relative to the first housing section 114. During a post-manufactured retrofit, or an upgrade of the data storage device 52 (FIG. 2), it can be desirable to replace an existing or damaged optical label with an improved set of identifiers. After removing the damaged or outdated optical label, the device RFID tag 60 is secured to the exterior surface 108 of the first housing section 114 and a new optical label 148 is disposed over the device RFID tag 60. Again, it is desirable that the device RFID tag 60 include at least a subset, and in particular, at least the VOLSER number, of the data that is printed on the optical label 148.

With additional reference to FIG. 2, in one embodiment the exterior surface 108 of the first housing section 114 is provided with an integrally molded label relief that defines a cavity sized to receive the chip 142 of the device RFID tag 60. The integrally molded label relief preferably provides an exit path for the mold components to be removed relative to the first housing section 114 after the molding step, and in this regard, is molded to be a “three-sided” label relief that is sized to accept a perimeter of the optical label 148.

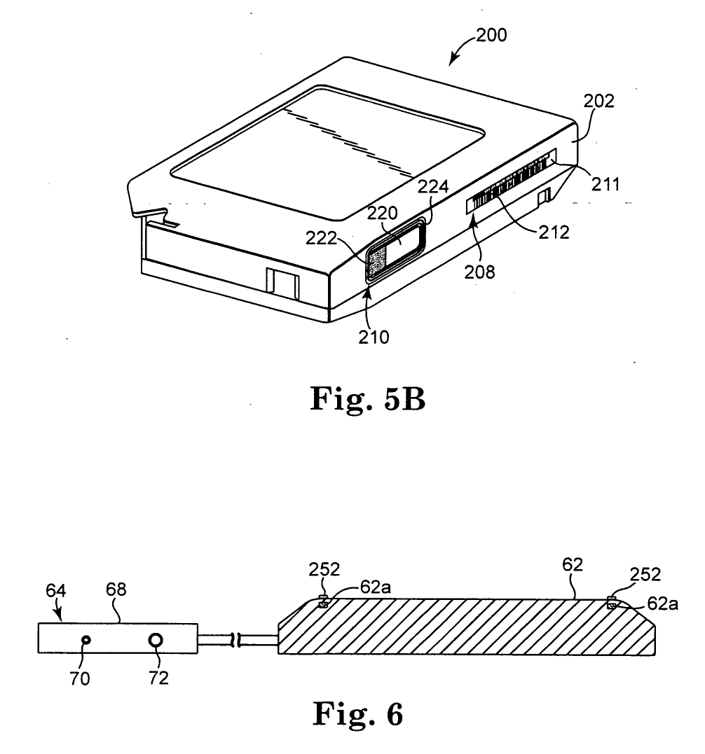

Aspects of the present application can be broadly applied to any manner or style of data storage device, and is not limited to the data storage tape cartridge illustrated in FIG. 2. For example, FIG. 5A illustrates a perspective view of a data storage device 150 according to another embodiment of the present invention. The data storage device 150 provides an example of a micro hard drive including a housing 152 having an optical label 158 and a device RFID tag 160 coupled to the housing 152. In one embodiment, the optical label 158 includes a bar code having various data fields including a media number field 161 and a VOLSER number field 162.

In one embodiment, the device RFID 160 includes a backing 170, a silicon chip 172, and an antenna 174. The backing 170 is highly similar to the backing 140 (FIG. 2) and defines a substrate that is configured to retain the silicon chip 172 and the antenna 174. It is to be understood that a superstrate (not shown) would typically be provided to cover the device RFID tag 160 such that the silicon chip 172 and the antenna 174 would not necessarily be visible. In addition, although the optical label 158 and the device RFID tag 160 are illustrated as positioned on an exterior of the housing 152, it is to be understood that these structures could be placed anywhere on the housing 152. For example, in one embodiment the device RFID tag 160 is integrated to a position within the housing 152. In any regard, the data storage device 150 includes at least a VOLSER number printed in the VOLSER number field 162 on the optical label 158 and an identical electronically stored VOLSER number in the silicon chip 172, such that the reader system 54 (FIG. 1) is configured to read the VOLSER number and trace the data storage device 150 entering/exiting the antenna pad 62 (FIG. 1).

FIG. 5B illustrates a perspective view of a data storage device 200 according to another embodiment of the present invention. The data storage device 200 provides an example of a micro hard drive including a housing 202 having an optical label 208 and a device RFID tag 210 coupled to the housing 202. In one embodiment, the optical label 208 includes a bar code printed with at least a media number field 211 and a VOLSER number field 212, and the device RFID 210 includes a backing 220, a silicon chip 222, and an antenna 224. In one embodiment, the device RFID tag 210 is located where an optical label is typically placed on such a device, and could be covered by the optical label 208, for example.

The backing 220 is highly similar to the backing 140 (FIG. 2) and defines a substrate that is configured to retain the silicon chip 222 and the antenna 224. It is to be understood that a superstrate (not shown) would typically be provided to cover the device RFID tag 210 such that the silicon chip 222 and the antenna 224 would not necessarily be visible. In addition, although the optical label 208 and the device RFID tag 210 are illustrated as positioned on an exterior of the housing 202, it is to be understood that these structures could be placed anywhere on the housing 202. For example, in one embodiment the device RFID tag 210 is integrated to a position within the housing 202. In any regard, the data storage device 200 includes at least a VOLSER number printed on in the VOLSER number field 212 of the optical label 208 and an identical electronically stored VOLSER number in the silicon chip 222, such that the reader system 54 (FIG. 1) is configured to read the VOLSER number and trace the data storage device 200 entering/exiting the antenna pad 62 (FIG. 1).

In one embodiment, the data storage device 200 is a 2.5 inch SATA hard disk drive and the housing 202 substantially replicates a tape cartridge. In this manner, the data storage device 200 conforms to industry standard tape cartridges, and is compatible with existing tape automation equipment and software. In one embodiment, the data storage device 200 is a sealed, anti-static hard disk drive cartridge having a form factor that is suited for library cases, racks, and like manner of cartridge carousels.

FIG. 6 illustrates a cross-sectional view of the pad antenna 62a showing the reader unit 64 in the background. In one embodiment, the pad antenna 62a includes an embedded rectangular copper antenna 62a and an alignment guide 252 disposed about a perimeter of the antenna 62a. In general, it is preferred that the antenna 62a is larger than a perimeter of the data storage device 52, or a set of multiple data storage devices 52 within a container configured for placement on the antenna pad 62. The alignment guide 252 is provided to ensure that the container is placed on the pad antenna 62a such that the data storage device(s) 52 are within a field of the antenna 62a. To this end, in one embodiment the alignment guide 252 is integrally molded on the antenna pad 62 such that a periphery of the alignment guide 252 approximately centers the device RFID tags 60 within a field of the antenna 62a. In an alternative embodiment, the alignment guide 252 is printed indicia (i.e., a decal) that guides placement of the data storage device(s) 52 relative to the pad antenna 62. In this regard, in one embodiment the antenna 62a is disposed over an area of about 440 mm by 550 mm to provide a maximum field out to a furthermost edge of the alignment guide 252 and the data storage device(s) 52 in contact with the pad antenna 62.

In some embodiments, multiple pad antennas 62 are disposed in a row in order to ensure that the fields generated by the antenna 62a is larger than a perimeter of the data storage device 52, or a carton of multiple data storage devices, that is placed on the pad antenna 62. In other embodiments, two antenna pads 62 are oriented orthogonally one to the other such that the field generated by the antennas 62a intersects in a perpendicular manner to ensure that any random orientation of the device RFID tag 60 is readable. Although not shown, scanners/multiplexers and power splitters may be used to connect multiple antennas to a reader.

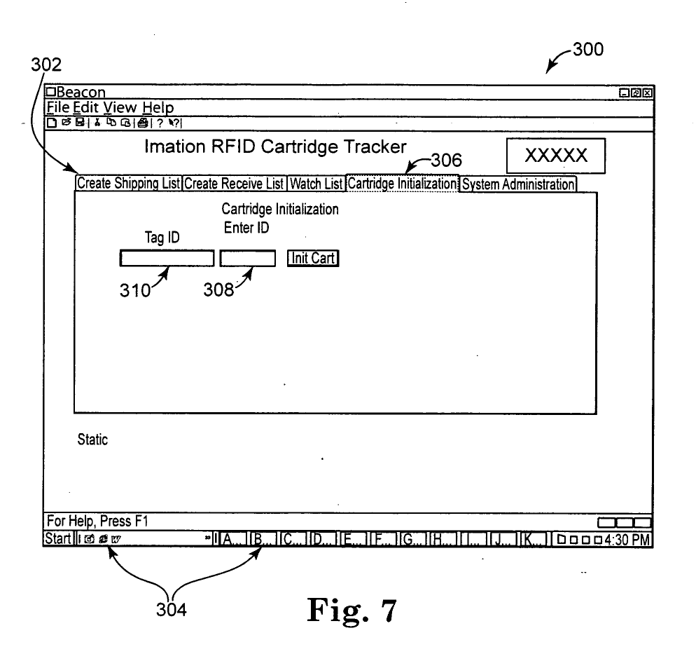

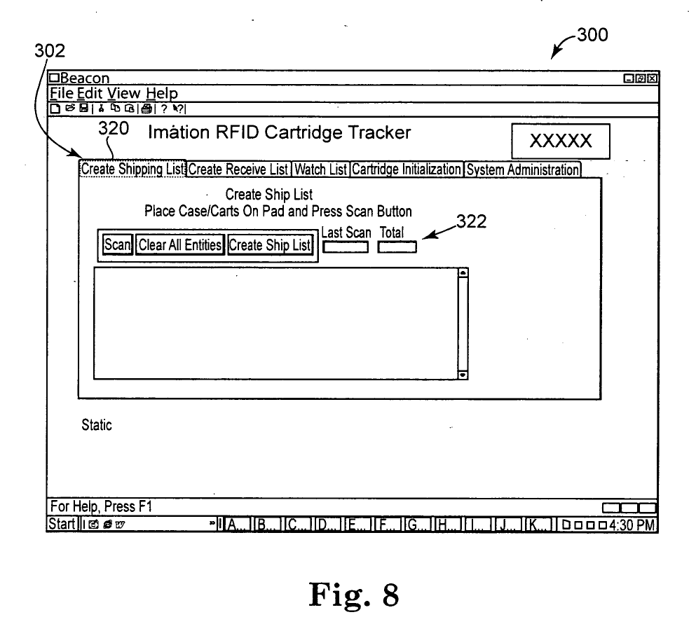

FIG. 7 illustrates a program 300 operable with the reader system 54 (FIG. 1) according to one embodiment of the present invention. The program 300 includes a menu 302 including a plurality of user selected functions, and a program list 304. In one embodiment, the menu 302 provides applications that create and compile lists that enable a user to trace the whereabouts of the data storage device(s) 52 (FIG. 1). The program list 304 identifies multiple other programs that are configured to electronically communicate with the program 300 in sharing and transferring of data files between users and/or facilities.

In general, and with additional reference to FIG. 1, the program 300 communicates through the software operable by the reader unit 64 and the GUI software operable by the GUI 66. The program 300 is adapted to read one or more data storage devices 52, create a report relative to the data storage devices 52 that have been read, compile a report, and verify that the data storage devices 52 are in transit (are being traced). In one embodiment, the program 300 is operable to electronically verify, for example by e-mail, that the transported data storage device(s) 52 have been received at a terminus end. In this manner, the creation of a report, the compilation of a report, and the verification of the transit enable the useful tracing of one or more data storage devices 52 between a starting location, such as a business office for example, and a terminating location, such as a storage facility.

In one embodiment, the menu 302 includes a cartridge initialization tab 306 that is configured to identify and initialize a new cartridge entering the reader system 54. A user activating the tab 306 is prompted to enter an ID in field 308. In one embodiment, the ID entered in field 308 is a VOLSER number generated by the user that is to be assigned to the data storage device 52, and in particular, to the device RFID tag 60 attached to the device 52. In other embodiments, a sorted table of label serial numbers and corresponding VOLSER numbers associated with multiple data storage devices 52 is stored on a mass storage device within memory unit 74, and the reader system 54 is operable to enter a suitable corresponding VOLSER number for a selected one of the devices 52 into the ID field 308. In a similar manner, a tag ID for a selected one of the devices 52 can be either scanned or entered into field 310. Once initialized, the data storage device 52 is usable to store data and is configured for tracing via the system 50.

FIG. 8 illustrates the program 300 employed to create a shipping list of one or more data storage devices 52. With reference to FIG. 1, the menu 302 has been accessed by the user and a shipping list tab 320 is selected that creates a drop down menu 322. The shipping list tab 320 prompts a user to place one or more data storage devices 52 onto the antenna pad 62 and initiate the reader system 54 to scan all of the placed data storage devices 52 at once. The reader system 54 scans the entirety of the device RFID tags 60 within its field and automatically identifies all of the recognized data storage devices 52 in a listing of the drop down menu 322. In this manner, the graphical user interface 66 enables a user to scan and create a shipping list of one or more data storage devices 52. One embodiment of the drop down menu 322 prompts the user if one or more of the data storage devices 52 has been incorrectly read, or not read, by the reader system 54. The user can manually enter the unread data or scan the unread devices 52 with a handheld scanner, for example.

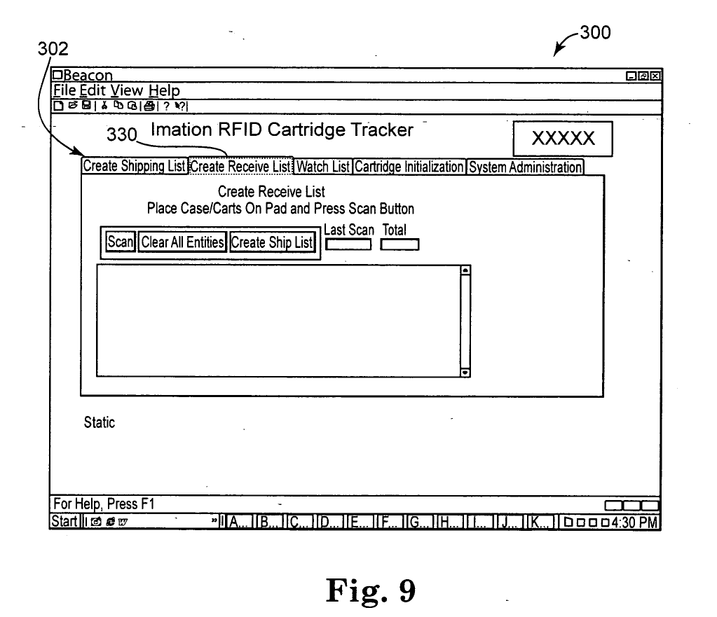

FIG. 9 illustrates the program 300 employed to identify one or more data storage devices as they are received in a facility. In this aspect of the program 300, the menu 302 is accessed by the user to create a receive list 330. One or more data storage devices 52 entering into a facility are placed on the pad antenna 62a and the program 300 is used to automatically scan the arrival of the data storage devices 52. The reader unit 64 recognizes/reads the VOLSER number of each scanned device 52 and generates a raw list of scanned devices 52. The GUI 66 generates a receive list 330 of devices 52 that have been received on the pad antenna 62. In one embodiment, the receive list generated by the GUI 66 is an XML formatted list. In this manner, the reader system 54 is operable to trace one or more data storage devices as they are received at a facility, such as when multiple data storage devices are retrieved from storage and brought back to headquarters or another business location.

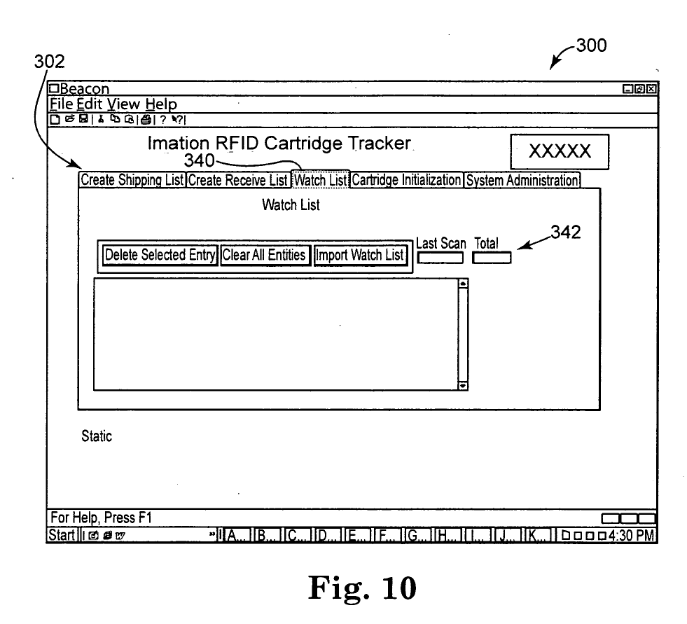

FIG. 10 illustrates the program 300 employed to create a watch list 340 for one or more data storage devices traced by the system 50. The watch list 340 can be updated based upon user preferences and enables a user to watch for one or more data storage devices 52 as they are traced via the system 50. For example, in one embodiment, the user enters a VOLSER number of a device 52 of interest into the field 342, and the program 300 is operable to notify the user when the device 52 having the VOLSER number of interest enters/exits within range of the pad antenna 62. In this manner, as a data storage device 52 arrives or exits pad antenna 62, the user is notified by the program 300 of the presence of that particular data storage device 52. Similarly, the watch list 340 is operable to seek multiple data storage devices 52 transiting the system 50.

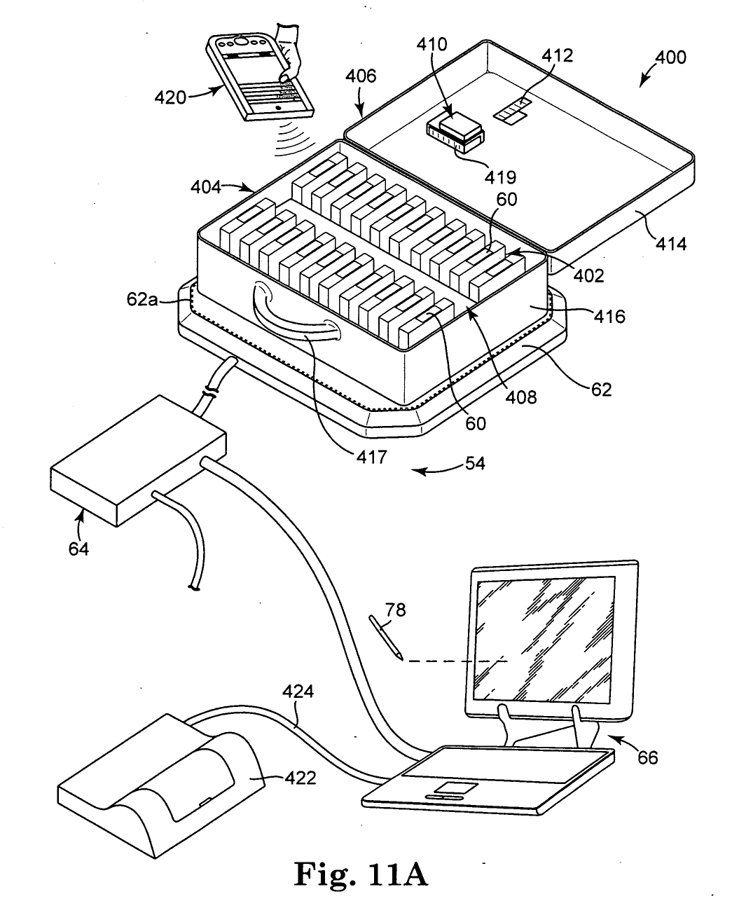

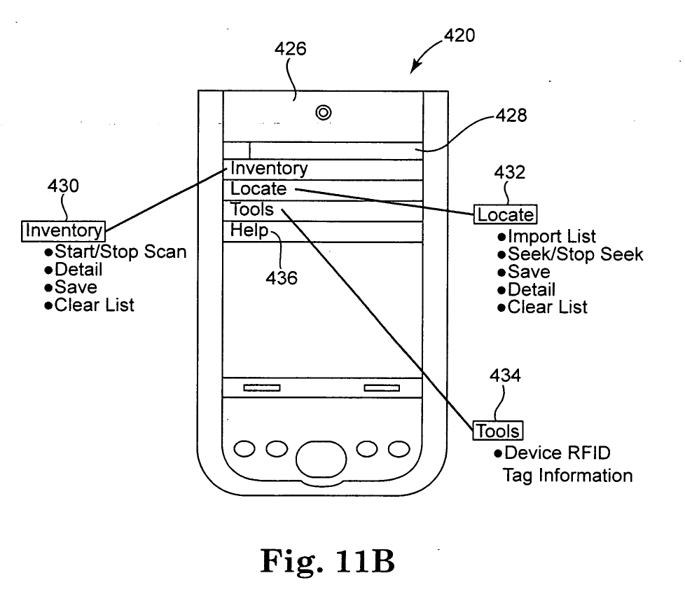

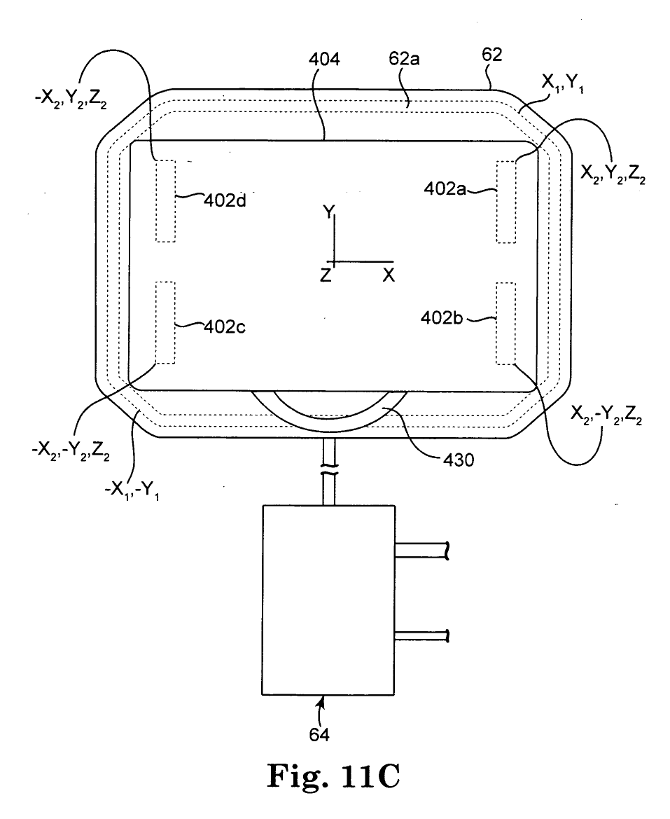

FIG. 11A illustrates a perspective view of an electronic data storage device tracing and tracking system 400 according to another embodiment of the present invention. The tracing and tracking system 400 includes multiple data storage devices 402 maintained within a case 404, where the reader system 54 is configured to trace and read an entirety of the device RFID tags 60 associated with the multiple data storage devices 402 in one pass of the case 404 across the field of the pad antenna 62.

In one embodiment, the case 404 defines an enclosure 406 provided with an insert 408, a global positioning system (GPS) unit 410 coupled to the enclosure 406 that enables tracking of the case 404 and the devices 402, and a case RFID tag 412 coupled to the enclosure 406. In one embodiment, the case 404 includes a first section 414 and a second section 416, where the first section 414 is a cover and the second section 416 is a base. The cover 414 includes the tracking GPS unit 410 and the case RFID tag 412 coupled to the cover 414. In this regard, the cover 414 is illustrated in an open position to provide a better view of the multiple data storage devices 402 in the base 416, although it is to be understood that tracing and tracking of the devices 402 is preferably accomplished by maintaining the cover 414 in the closed position.

In one embodiment, the case 404 is a molded case of a durable plastic resin and includes the cover 414 movably coupled to the base 416, and a carrying handle 417 coupled to the base 416. In general, the case 404 is sized to accommodate multiple data storage devices 402. In one embodiment, each data storage device 402 occupies a volume of about 29 cm³ and the case 404 is sized to contain about twenty such devices 402 within the enclosure 406. The case 404 can be molded from any suitable engineering plastic, such as polyester, polycarbonate, high density polyethylene, and the like. One suitable case 404 is molded from Lexan™ HPX polycarbonate resin, available from GE Advanced Materials, Fairfield, Conn. Suitable cases 404 are available from Hardigg, South Deerfield, Mass., and are identified as STORM CASE®.

The insert 408 is removably formed within the base 416 and is preferably a molded plastic insert configured to retain each of the multiple data storage devices 402 in a manner that orients the device RFID tags 60 perpendicular to the field generated by the pad antenna 62, which enables the reader system 54 to quickly and accurately read the multiple device RFID tags 60. In this regard, it is desired that the base insert 408 not interfere with the radio frequency reading of the device RFID tags 60 attached to the devices 402. In one embodiment, the insert 404 includes multiple layers of cubed foam that can be customized to accommodate one or more data storage devices 402. In another embodiment, the insert 408 is a molded plastic insert, formed from suitable polymers such as polyolefins and the like, or other plastics. In this regard, the insert 408 can be either a rigid insert or a compliant insert.

The GPS unit 410 is a suitable global positioning system including cellular telephony technology that enables digital communication between the system 50 (FIG. 1) and the case 404 in which the GPS unit 410 is located. One suitable GPS unit 410 is available from, for example, Magellan, San Dimas, Calif. and is modified to included cell phone satellite tracking technology (i.e., the GPS unit includes cell phone circuitry). In one embodiment, the GPS unit 410 includes a GPS RFID tag 419 that is similar to the device RFID tag 60 (FIG. 3A) and is configured to communicate with the reader unit 64 (FIG. 1). In this manner, when the GPS RFID tag 419 (which is attached to the GPS unit 410, which is preferably located inside the case 404) is present on or near the antenna pad 62, the GPS RFID tag 419 is activated to an “on” state, which activates the cellular telephone satellite tracking function of the GPS unit 410 to enable global position tracking of the case 404 and the data storage devices 402 inside the case 404. During periods in which the case 404 is in storage, the GPS unit 410 is maintained in an “off” state to preserve battery life, and is selectively turned to the on state as the GPS RFID tag 419 (and the GPS unit 410 to which it is attached) passes over the antenna pad 62.

The case RFID tag 412 is similar to the device RFID tag 60 (FIG. 3A). In this regard, the case RFID tag 412 includes multiple electronic memory data fields stored on an electronic chip. In one embodiment, the case RFID tag 412 stores an identifier within its memory that associates that particular case RFID tag 412 with the case 404 to which it is attached. In this manner, the software of the GUI 66 (FIG. 1) is configured to associate a particular case 404 with specific data storage devices 402 stored within the case 404. In an alternative embodiment, the case RFID tag 412 electronically stores data fields that include data for the VOLSER numbers of the multiple data storage devices 402, or other data indicative of the identity and disposition of the devices 402. By the embodiments above, one or more or all of the data storage devices 402 are traceably associated with the case 404 to which the case RFID tag 412 corresponds. The case RFID tag 412 can include data related to source of origin of the case 404, identifiers of the contents of the case 404, identifiers for the devices 402 in the case 404, and other data useful in tracing the devices 402 and the case 404. Since the case 404 is larger than the devices 402 stored within the case 404, the case RFID tag 412 can be sized to be larger than the device RFID tag 60, which enables easier and more reliable reading of the case RFID tag 412 with a handheld reader, for example. The case RFID tag 412 can be placed anywhere on the case 404, although it is preferred that the case RFID tag 412 be placed within the case 404. In one embodiment, the location of the case RFID tag 412 within the case 404 is identified on an exterior of the case 404, with a mark or other indicia, for example.

In one embodiment, the tracing and tracking system 400 includes an optional portable reader device 420 configured to read one or both of the optical tag 58 (FIG. 2) and/or the device RFID tag 60. In one embodiment, the portable reader device 420 is an optical reader device. In another embodiment, the portable reader device 420 is an RFID reader transceiver. In other embodiments, the portable reader device 420 is a handheld personal data assistant (PDA) 420 provided with a docking cradle 422 and a synchronization cable 424 suited for downloading and/or transmitting data between the PDA 420 docked in the cradle 422 and the GUI 66. In some circumstances, the VOLSER number (described above) is corrupted or otherwise unreadable, and the portable reader device 420 is provided to enable a user to directly interrogate the optical label 58 to determine the VOLSER number corresponding to one or more of the data storage devices 402. In this regard, in one embodiment the portable reader 420 is also configured to write a suitable VOLSER number to one or more of the data storage devices 402.

As a point of reference, in some circumstances the case 404 is a metallic case that interferes with the sending and receiving of radio frequency signals within the reader system 54. To this end, in one embodiment the case 404 includes the cover 414 that can be opened to expose the optical label 58 and the device RFID tag 60 on the multiple data storage devices 402 for direct reading by the portable reader 420. In a preferred embodiment, the case 404 is a plastic case that is configured to enable the reader system 54 to read the identity of the multiple data storage devices 402 within the case 404 without having to open the cover 414.

FIG. 11B illustrates a front view of the PDA 420 operating application software that transfers information between the device RFID tags 60 (FIG. 11A) and the GUI 66 (FIG. 11A). In one embodiment, the PDA 420 includes an RFID card (not shown) and a secure digital input/output slot 426. One suitable RFID card is available from Wireless Dynamics, Inc., Calgary, Alberta, Canada and is identified as SDID 1020 RFID card. In general, the PDA 420 employs user commands to operate application software to start and stop RFID scanning activity. For example, while the PDA 420 is scanning, a user passes the inserted RFID card over the device RFID tags 60 to collect and scan information. Such collected information may then be examined in detail, or saved to a file. In this regard, during scanning the swipe speed of the PDA 420 over the devices 402 (FIG. 11A) ranges from about one cartridge every two seconds to about ten cartridges per second, although other swipe speeds are also acceptable.

The PDA 420 includes a variety of personal digital assistants operable with Windows Mobile 5.0 software or higher. One suitable PDA includes Dell Axim X51v available from www.dell.com.

The application software operable by the PDA 420 is designed to work in the environment described above in reading and writing to the device RFID tags 60. The PDA 420 includes a status line 428 that is visible throughout the session when accessing the dialog tabs. A variety of dialog tabs are provided including an inventory tab 430, a locate tab 432, a tools tab 434, and a help tab 436.

The inventory tab 430 includes controls that are employed to support performing a device inventory and includes a listbox that stores the VOLSER numbers of scanned devices and a series of command buttons. The series of command buttons includes a start/stop scan button that is employed to place the device RFID tag 60 into and out of a scanning mode. When scanning, VOLSER numbers of located devices 402 are inserted into the listbox. If the device RFID tag 60 information is validated (for example via the CRC check described above), the VOLSER number is prominently displayed. If the device RFID tag 60 information is not validated, a flag is displayed, such as the VOLSER number being displayed in red text. A text message can be displayed beneath the listbox for documenting a count of how many devices have been scanned.

The detail command button is employed to display a modal dialog containing detailed information related to the VOLSER number currently selected in the listbox. For example, such information can include the unique tag identifier, the revision number, the VOLSER number, and the CRC described above.

The save command button can be employed to save information on scanned devices. In one embodiment, the information is saved in encrypted format. Tapping the save command button will bring up a modal dialog box in which save options are presented prior to the actual creation of a saved file.

The clear list button will clear information from the listbox.

The locate tab 432 is employed to locate devices from an imported watch list. As with the inventory tab 430, accessing the locate tab 432 provides a listbox with VOLSER numbers of the as-identified watch list items and a series of command buttons. The series of command buttons includes an import list button that is useful to bring up a file selection dialog, where the selected file contains a list of VOLSER numbers in a predefined format. VOLSER numbers are read from the file, and inserted into the list box in text.

The seek/stop seek command button is employed to engage the scan card between an in-scan mode and an out of scan mode. While scanning, if a device in the watch list is detected, the VOLSER number in the listbox is changed to a green color, for example, to indicate that the watched-for device 402 has been located. A text box beneath the listbox contains a count of matching or matched devices.

The save button enables a user to save the results of the locate operation to a file. Tapping this button will present a modal dialog in which save options are specified prior to the actual creation of a saved file.

The detail and clear list buttons have the same function on the locate tab 432 as on the inventory tab 430.

The tools tab 434 is employed to access diagnostic utilities of the PDA 420. In one embodiment, a card information button is toggled to display a modal dialog regarding information on the device RFID tag 60 or the SD card.

The help tab 436 stores information on the software version and support information. In one embodiment, the help tab 436 is non-interactive.

In one embodiment, moving files from the PDA 420 to the GUI 66 employs synchronization software that is best accessed when the PDA 420 is docked in the cradle 422 (FIG. 11A).

FIG. 11C illustrates a simplified top view of the case 404 containing the cartridges 402 positioned on the antenna pad 62. The simplified view illustrates four data storage devices 402a, 402b, 402c, 402d that are disposed in peripheral corners of the case 404. In this regard, the data storage devices 402a-402d are positioned at an outermost extent within the case 404 (and thus, the farthest distance from a center of the antenna 62a), which presents a challenge to the antenna 62a in reading the device RFID tags 60 (FIG. 11A) affixed to each of the devices 402.

With this in mind, an X-Y-Z coordinate system is imposed on the antenna pad 62 near an approximate center of the antenna 62a with Z=0 at a surface of the antenna pad 62. The perimeter of the antenna 62a is associated with coordinates X1, Y1 in the plane of the antenna pad 62. An outermost extent of each of the cartridges 402a-402d is associated with coordinates X2, Y2, Z2. For example, the data storage device 402a presents an outermost corner positioned at coordinates X2, Y2, Z2. Following this convention, the data storage device 402c presents an outermost corner of the cartridge located at −X2, −Y2, Z2. It is desired to optimize the field output from the antenna 62a to ensure that all of the device RFID tags 60 are readable by the antenna 62a, even if the tags 60 are placed at the outermost corners, and to minimize the far field emission from antenna 62a in compliance with various governmental regulations.

Table 1 provides exemplary dimensions (in meters) for sizing the antenna 62a to minimize far field emissions, and provides dimensions that result in maximizing the output of the antenna 62a. A separate set of dimensions is provided for minimizing the quality factor (Q) of antenna 62a. Note that the dimensions in Table 1 are positive, such that an entire X axis dimension for a size of the antenna 62a is obtained by calculating the distance between the minus X position (−X) and the positive X axis dimension (+X) in reference to FIG. 11B. For example, one exemplary dimension of an antenna for minimizing the far field emission is 0.5 m by 0.27 m (or twice the dimensions in Table 1). Case 1 recognizes a general orientation of the case 404 relative to the antenna pad 62, and case 2 is specific to an orientation in which the field of the antenna 62a reads the device RFID tags 60 through the cover 414.

With reference to Table 1, in one embodiment the antenna 62a is sized to have an X axis dimension of about 480 mm and a Y axis dimension of about 280 mm to minimize far field emission from the antenna 62a. In another embodiment, the antenna 62a is sized to have an X axis dimension of about 700 mm and a Y axis dimension of about 500 mm to maximize the output of the antenna 62a relative to the current through the antenna 62a. It is desired, in general, to configure the antenna 62a to have dimensions roughly within these parameters in balancing the power/range of the antenna 62a with the emitted field of the antenna 62a. To this end, one of skill in the art of antennas will readily recognize that other dimensions for the antenna 62a are also acceptable.

TABLE 1

| | | Antenna | | Location of | | |
|---|---|---|---|---|---|---|
| | | Corner (m) | | Device Corners (m) | | |
| | | X1 | Y1 | X2 | Y2 | Z2 |
| Minimize | Case 1 | .25 | .135 | .18 | .1 | .15 |
| Far Field | Case 2 | .24 | .14 | .18 | .1 | .1 |
| Emissions | | | | | | |
| Maximize | Case 1 | .35 | .25 | .18 | .1 | .15 |
| Antenna | Case 2 | .29 | .2 | .18 | .1 | .1 |
| Output | | | | | | |

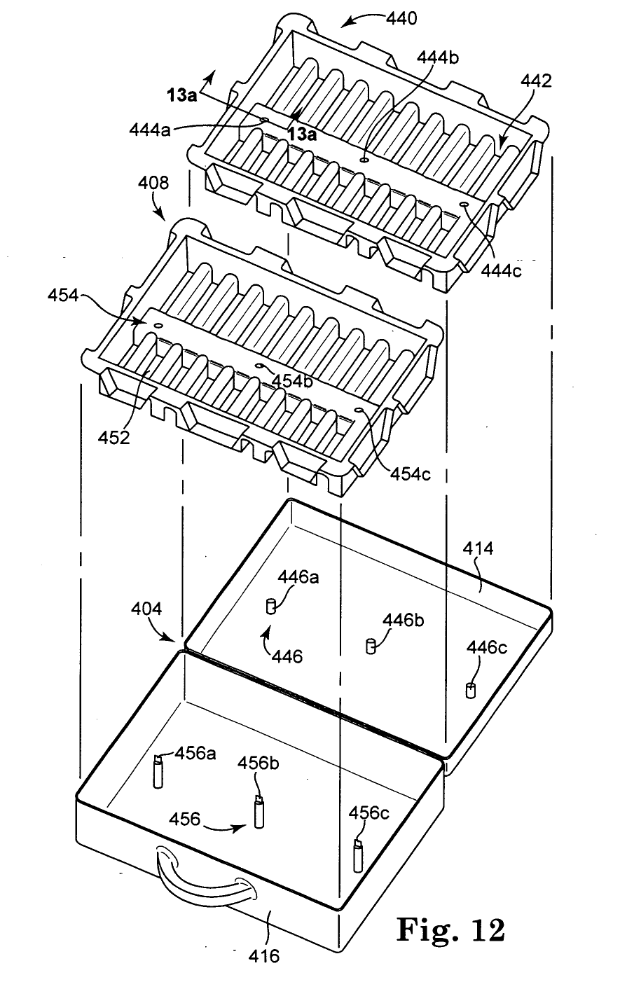

FIG. 12 illustrates an exploded, perspective view of the base insert 408 and a cover insert 440 extracted from the case 404 according to one embodiment of the present invention. The cover insert 440 is preferably durably retained within the cover 414 as the cover 414 moves between the open and closed positions. In general, the cover insert 440 defines a plurality of device slots 442 and relief portions 444 that mate with projections 446 extending from an interior of the cover 414. In particular, in one embodiment the cover insert 440 defines three relief portions 444a, 444b and 444c that mate with a respective projection 446a, 446b and 446c that extend from the cover 414. In some embodiments, it is desirable to semi-permanently mate the projections 446 with the relief portions 444 in a manner that necessitates the destruction of one or both of the projections 446 and/or the relief portions 444 when removing the cover insert 440. This ensures that the cover insert 440 will be retained within the cover 414, unless or until it is desired to forcefully remove the cover insert 440, during maintenance of the case 404, for example.

In one embodiment, the base insert 408 includes a plurality of device slots 452 and defines relief portions 454a, 454b, 45c that are sized to mate with projections 456a, 456b, 456c, respectively, extending from an interior of the base portion 416. Each of the device slots 452 is sized to frictionally retain an individual one of the data storage devices 402 in a manner that orients the device RFID tag 60 perpendicular to the field that is generated by the pad antenna 62 (FIG. 11A). In this regard, in one embodiment the base insert 408 is formed of a compliant material that enables each one of these slots 452 to accept a device 402 that is pressed into the slot 452.

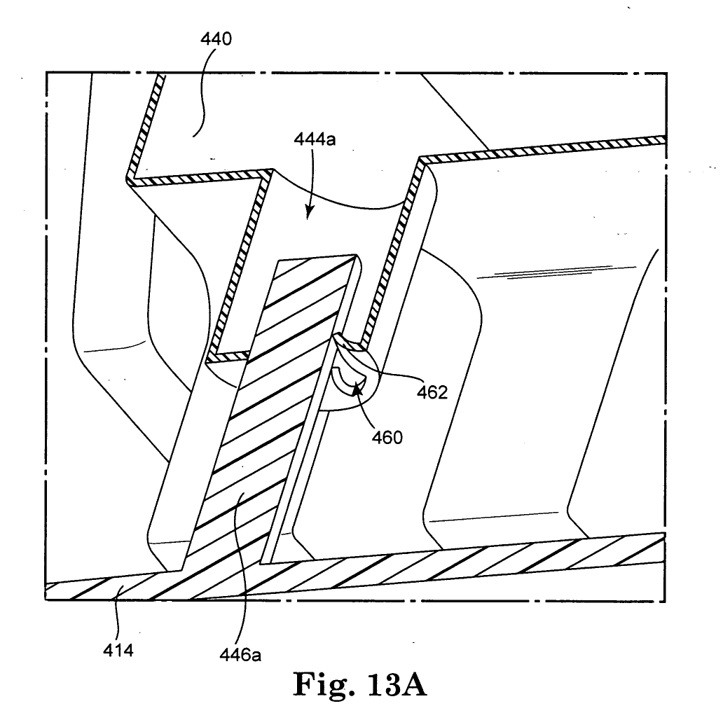

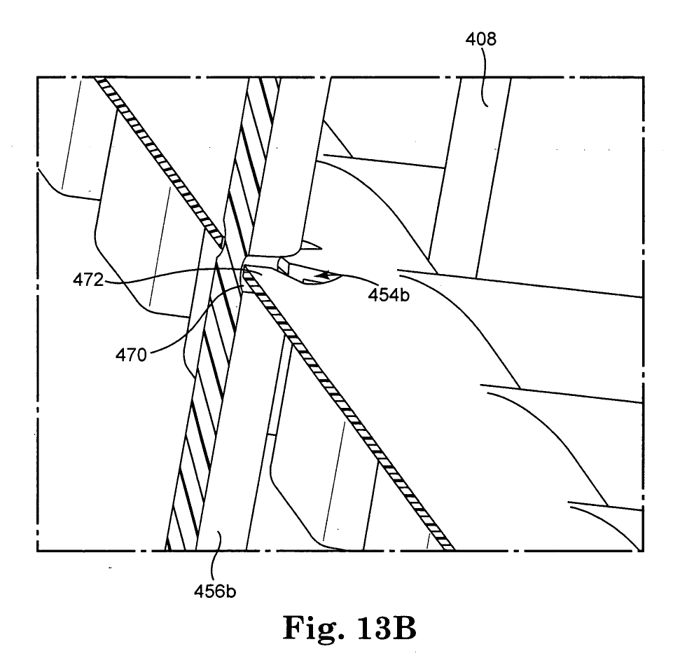

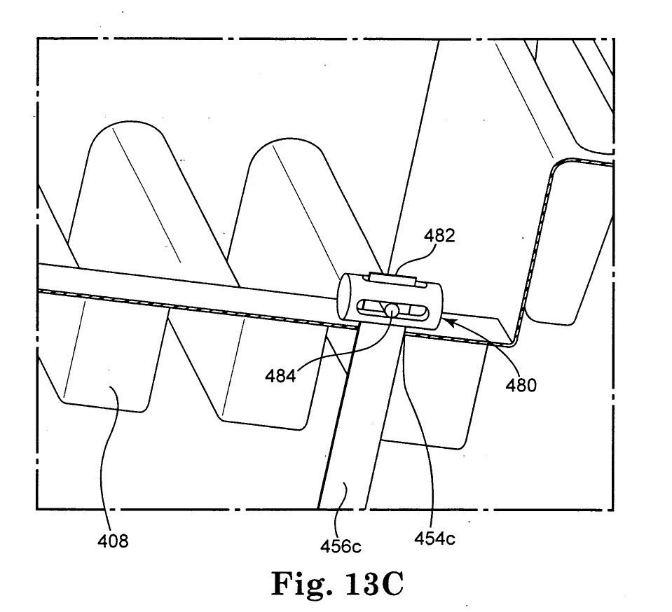

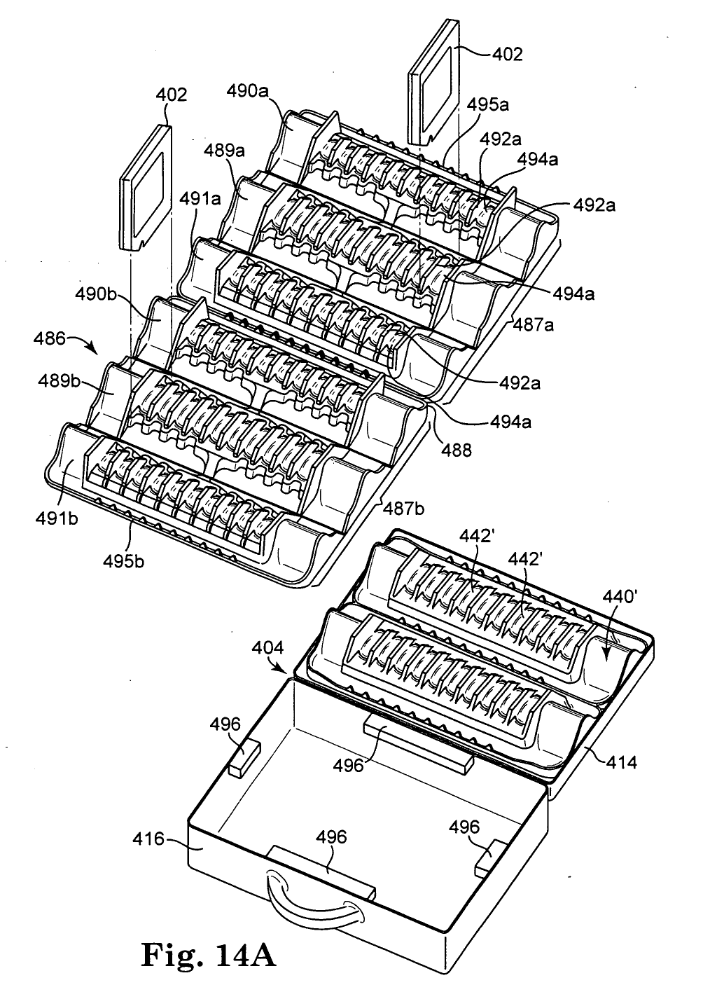

FIG. 13A illustrates a cross-sectional view of the cover insert 440 engaged with the projection 446a. In one embodiment, each relief portion 444 defines a star-shaped opening 460 that is formed by one or more flanges 462. In general, it is desired that the cover insert 440 be secured against unintended removal from the cover 414. In one embodiment, the flanges 462 are configured to deform around the projection 446a such that the flanges 462 are destructively attached to the projection 446a. That is to say, the flanges 462 are compressed against the projection 446a in a manner that prevents the projection 446a from backing out (or away) from the flanges 462. In this regard, the relief portion 444a defines a lock that can be push-fit against the projection 446a such that the flange 462 bends up (relative to the orientation of FIG. 13A) and prevents the cover insert 440 from slidably releasing from the projection 446. An attempt to withdraw the cover insert 440 from the cover 414 will destroy one or more of the flanges 462. Thus, in one embodiment the cover insert 440 is a part of a reusable cover 414 that would not be changed out except when the cover 414 becomes damaged and is replaced in its entirety during maintenance of the cover 414.

FIG. 13B illustrates the base insert 408 removably locked relative to a projection 456b of the base 416. In one embodiment, the projection 456b is a uniformly smooth cylindrical projection that is sized to press-fit into a circular relief portion 454b such that the base insert 408 is retained within the base 416. In another embodiment, the projection 456b defines a collar 470 that is relieved to removably retain a flexible flange 472 of the relief portion 454b. The relief portion 454b removably locks relative to the projection 456b by enabling the flexible flange 472 to equilibrate to a neutral position within the collar 470. In this manner, the base insert 408 can be pulled off of the projection 456b for removal or maintenance.

FIG. 13C illustrates the base insert 408 selectively locked relative to a projection 456c of the base 416. In one embodiment, the projection 456c slideably mates with the relief portion 454c (best illustrated in FIG. 12) and a retainer assembly 480 is coupled to a top 482 of the projection 456c to removably retain the base insert 408 within the base 416. In one embodiment, the retainer assembly 480 includes a spring loaded peg 484 that biases between an open position and a closed position. In the open position, the spring loaded peg 484 is configured to provide clearance for the retainer assembly 480 to slide over the top 482 of the projection 456c. In the closed position, the spring loaded peg 484 clasps against the projection 456c to retain the base insert 408 inside the base 416 by preloading the base insert 408 against the projection 456c.

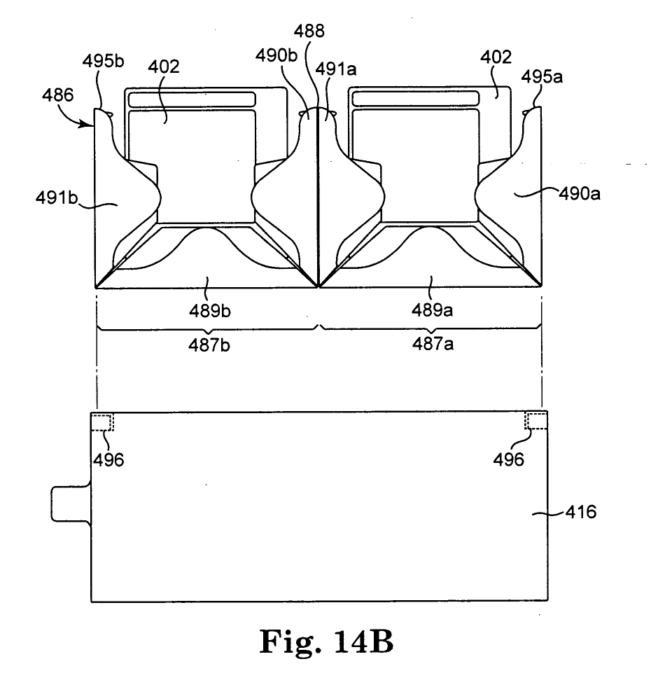

FIG. 14A illustrates a perspective, exploded view of the case 404 and an insert system 485 configured to retain multiple data storage devices 402 according to one embodiment of the present invention. The insert system 485 includes a cover insert 440′ and a base insert 486. The insert system 485 protectively retains the devices 402 within the case 404. The insert system 485 is configured to absorb jarring impacts and protect the devices 402 from shock. In this regard, it is desired to flexibly retain the insert system 485 within the case 404 in a manner that minimizes a rigid transfer of shock between the case 404 and the insert system 485 within the case 404, such that the devices 402 are isolated from shocks and bumps.

The cover insert 440′ is preferably durably retained within the cover 414 and defines a plurality of device slots 442′ that are sized to frictionally engage one end of a device 402 when the cover 414 is closed over the devices 402. In this manner, the cover insert 440′ is similar to the cover insert described in FIG. 12 above, and can include relief portions that mate with projections extending from an interior of the cover 414. In another embodiment, the cover insert 440′ is sized to be removably press-fit within an interior perimeter of the cover 414. The cover insert 440′ can be attached to an interior of the cover 414 by adhesive or mechanical fasteners such as hoop and loop fabric fasteners.

The base insert 486 includes a pair of foldable panels 487a and 487b hinged about an approximate central spine 488. Each of the panels 487a, 487b defines a respective seat portion 489a, 489b and opposing wings 490a, 491a and 490b, 491b that fold relative to the seat portions 489a, 489b. The seat portion 489a and the opposing wings 490a, 491a define device separators 492a. When the opposing wings 490a, 491a are folded over devices 402 placed in the seat portion 489a, the separators 492a separate the devices 402 for retention within a device slot 494a. In a similar manner, the seat portion 489b and the opposing wings 490b, 491b define device separators 492b such that when the opposing wings 490b, 491b are folded over devices 402 placed in the seat portion 489b, the separators 492b separate the devices 402 for retention within a device slot 494b. An outer side of each panel 487a, 487b defines a flange 495a, 495b, respectively, that is configured to be retained within lips 496 formed within the base 416.

The base insert 486 is formed of thermoplastic materials and can be formed in a variety of processes, such as blow molding, injection molding, press molding or other thermoplastic fabrication processes. In one embodiment, the base insert 486 is molded of an ultra low density polyethylene film (or a really low density polyethylene RLDPE), although other suitable polymers are also acceptable. For example, in one embodiment the base insert 486 is formed of a foamed thermoplastic material. In one embodiment, the base insert 486 is formed to be compliant such that when the insert 486 is retained within the base 416 it offers vibration damping and shock absorption that is useful in protecting the devices 402.

FIG. 14B illustrates an exploded side view of the base insert 486 folded around multiple data storage devices 402 and positioned relative to the base 416 of the cases 404. In this regard, to simplify the view of FIG. 14B, the cover 414 is not shown as attached to the base 416. The base insert 486 has been folded such that the panel 487a has been retracted relative to the central spine 488 and the wings 490a, 491a have been folded about the seat portion 489a to retain one or a row of the data storage device(s) 402. In a similar manner of folding, the panel 487b has been retracted relative to the central spine 488 and the wings 490b, 491b have been folded about the seat portion 489b to retain a separate one (or a separate row) of the data storage device(s) 402.

In the folded configuration illustrated in FIG. 14B, the flanges 495a, 495b are presented in a position opposite of the seat portions 489a, 489b such that the flanges are poised for retention within the base 416. With this in mind, although multiple devices 402 are illustrated as retained by the base insert 486, a more typical deployment would include folding the panels 487a, 487b toward one another absent the devices 402 and inserting the empty base insert 486 into the base 416. Thereafter, the wings 490a and 491b are extended upward such that the flanges 495a, 495b, respectively, are retained by the lips 496. The central spine 488 may then be fully seated within the base 416, and the devices 402 stowed in the base insert 486.

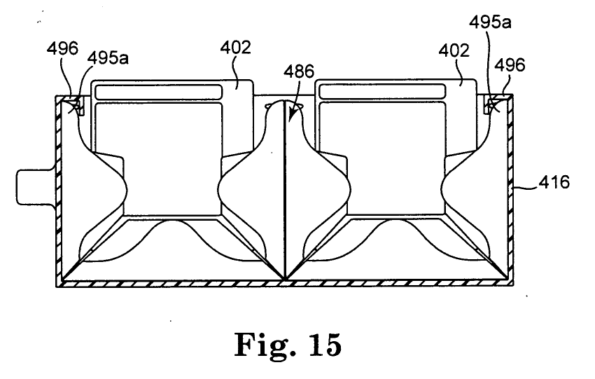

FIG. 15 illustrates a cross-sectional view of the base insert 486 retained within the base 416. The flanges 495a, 495b are retained by the lips 496 such that the base insert 486 is configured to be compliantly movable within the base 416. In this manner, the base insert 486 can move relative to the base 416 to facilitate shock absorption and vibration damping, which contribute to the protection of the devices retained by the base insert 486.

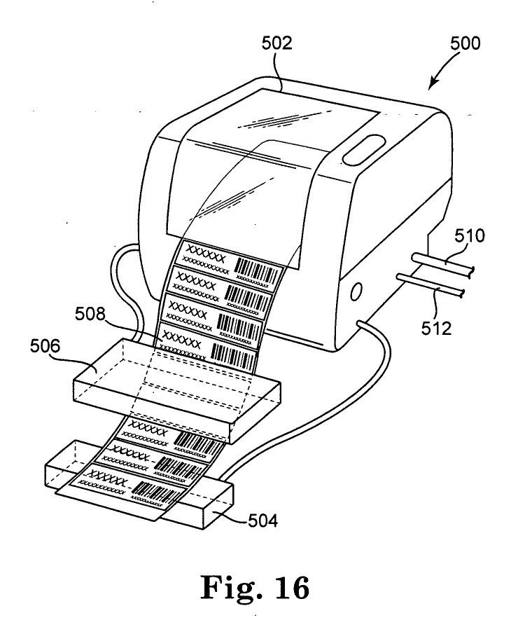

FIG. 16 illustrates a perspective view of a printer system 500 according to one embodiment of the present invention. The printer system 500 includes a label printer 502 coupled to an RFID reader 504 and an optical reader 506, both of which are in electrical communication with the printer 502. The label printer 502 is operable to print labels 508 that include at least one of a VOLSER number, a VOLSER color code, and/or a VOLSER bar code suitable for optical reading (including human viewing). The optical reader 506 is configured to read the printed labels 508 and communicate with the RFID reader 504. The RFID reader 504 is configured to write a corresponding VOLSER number and a corresponding VOLSER CRC (along with other electronic data) to an IC chip (not shown) of an RFID tag within the labels 508. In this regard, the label printer 502 includes a power source connection 510, and an output connection 512, such as an Ethernet connection or a universal serial bus (USB), that couples to the GUI 66 (FIG. 1).

The label 508 in one embodiment is highly similar to the optical label 58 (FIG. 2). In this regard, the printer system 500 is operable to electronically transfer from the GUI 66 (FIG. 1) any of the cartridge data stored on the GUI 66 that the user desires to write to the label 508. This is useful in assigning a new label to replace a damaged (or unreadable) label as the data storage device 52 (FIG. 1) enters/exits the system 50. To this end, the label 508 is printable with bar code and other optically readable data (such as a cartridge type code, a manufacturer code, the VOLSER number, the media number, and a date code), and any or all of this same data can be electronically written to a chip within the label 508 by the reader 504.

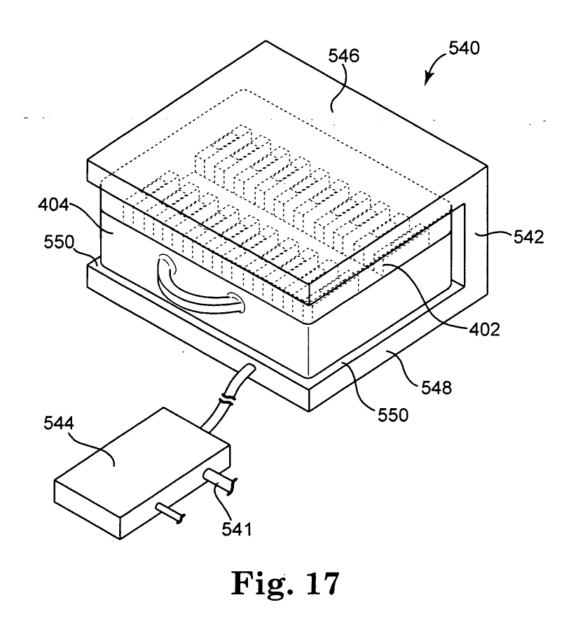

FIG. 17 illustrates a perspective of a reader system 540 according to another embodiment of the present invention. The reader system 540 is configured to provide an extensive radio frequency field that is enabled to read RFID tags irrespective of the orientation of the RFID tag. In this regard, the reader system 540 includes a U-shaped antenna assembly 542 and a transceiver 544. The U-shaped antenna assembly 542 includes multiple antennas, including at least a first antenna 546 and an opposing second antenna 548, both of which are electrically coupled to the transceiver 544. The first and second antennas 546, 548 are disposed in opposing portions of the U-shaped antenna assembly 542 that is otherwise configured to accommodate the case 404 storing multiple data storage devices 402. The transceiver 544 includes an output connector 541 that is suited for connection to a graphical user interface, such as the GUI 66 (FIG. 1), that enables the sharing of data between the GUI 66 and the transceiver 544.

In one embodiment, it is desired that each of the first and second antennas 546, 548 include an antenna having dimensions of about 350 mm×420 mm, although it is to be understood that other sizes of antennas are suitable and within the scope of this invention. Certain larger cases are more effectively read by an antenna having dimensions of about 370 mm×470 mm, for example. To this end, one embodiment of the U-shaped antenna assembly 542 provides guides 550 that are configured to position the case 404 at a desired location within a read field of the U-shaped antenna assembly 542.

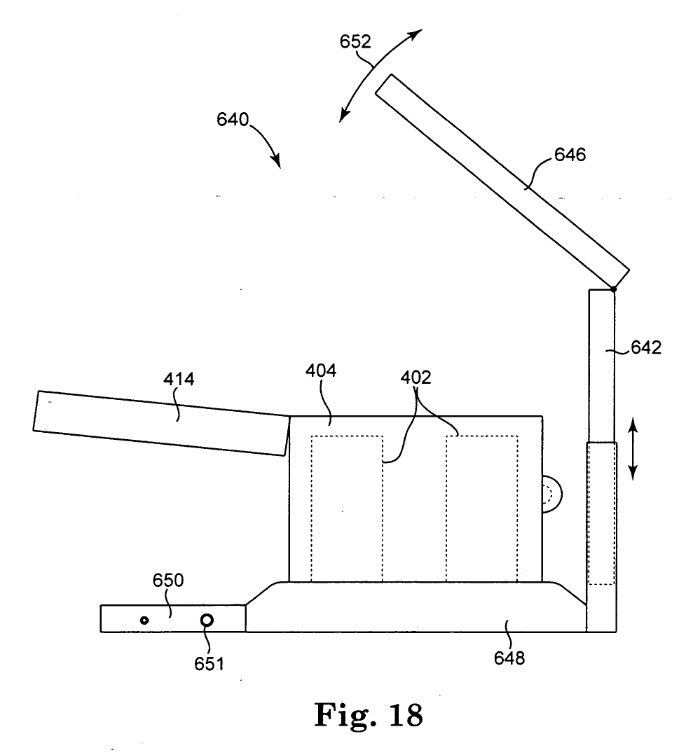

FIG. 18 illustrates a reader system 640 according to another embodiment of the present invention. The reader system 640 includes an adjustable antenna support 642 having a first hinged antenna 646 hinged to the adjustable antenna support 642, a second fixed antenna 648, and an RFID transceiver 650 in electrical communication with the antenna support 642. The RFID transceiver 650 includes an output connector 651 suited for connection to a graphical user interface, such as the GUI 66 (FIG. 1), that enables the sharing of data between the GUI 66 and the RFID transceiver 650.

In one embodiment, the adjustable antenna support 642 is height-adjustable, and the hinged antenna 646 is configured to move in an arc 652 of at least 90 degrees relative to the adjustable antenna support 642. The antennas 646, 648 are sized to ensure radio frequency reading of randomly oriented multiple data storage devices 402 stored in a generalized metallic case 404, for example. With this in mind, in an exemplary embodiment the hinged antenna 646 and the fixed antenna 648 each includes an antenna area of about 350 mm×390 mm.

Metallic cases 404 can interfere with RFID reading of the device RFID tags 60 (FIG. 11A) attached to the devices 402. The adjustable antenna support 642 is configured to accommodate a variety of case sizes and shapes, and the antenna 646 can be displaced to permit easy opening of the case 404, which is especially useful with metallic cases and in situations where a read error occurs with one of the devices 402. After positioning the cases within the antenna support 642, the hinged antenna 646 is moved into a downward position over the exposed data storage devices 402 to enable reading of the device RFID tags 60 on the data storage devices 402. In one embodiment, at least one of the first hinged antenna 646 and the second antenna 648 is provided with guides (not shown) that assist in aligning the case 404 relative to the hinged antenna 646 to ensure that the devices 402 are within the field of the antennas 646, 648.

In another embodiment, the antenna support 642 includes an embedded antenna (not shown) that is substantially similar to the antennas described above and configured to provide a field orthogonal to the fields generated by the antennas 646, 648. In this manner, the magnetic fields produced by the reader system 640 produce an optimized output with a minimum level of far field emissions.

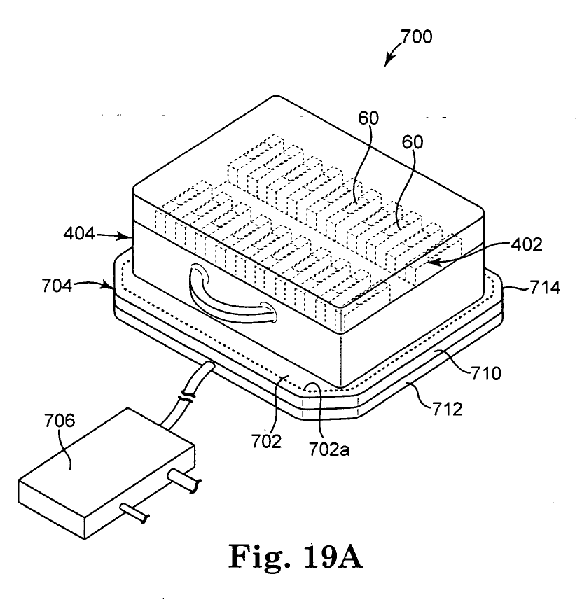

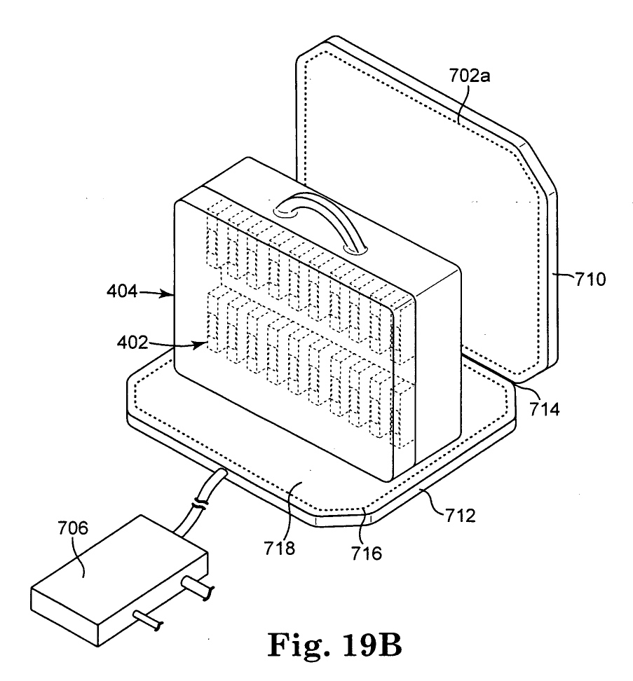

FIG. 19A illustrates a perspective view of a reader system 700 according to another embodiment of the present invention. The case 404 of data storage devices 402 is position on a first antenna surface 702 of a flip antenna assembly 704 that is electrically coupled to a transceiver/reader unit 706.

The flip antenna assembly 704 includes a first panel 710 and a second panel 712 that is rotatably connected to the first panel 710 along a hinged spine 714, for example. The first panel 710 includes the first antenna surface 702 provided with an embedded antenna 702a, the combination of which is configured to receive the case 404 and read the device RFID tags 60 attached to the storage devices 402. The first panel 710 is configured to rotate away from, and off of, the second panel 712 to produce intersecting RFID read fields. In this manner, two orthogonal fields are generated emanating from the first and second panels 710, 712, respectively, as best illustrated in FIG. 19B below, which enables RFID reading of device RFID tags 60 that might potentially be obscured from the field of one of the panels 710, 712.

The antennas within the panels 710, 712 are substantially similar to the antennas described above, including the antenna 62a (FIG. 1). In one embodiment, the antennas each have an antenna area of about 350 mm×390 mm, although other antenna sizes are also acceptable. The reader unit 706 is similar to the reader unit 64 described above, and communicates with software operable by the reader system 700 when communicating with the GUI 66 (FIG. 1).

FIG. 19B illustrates a perspective view of the reader system 700 showing the first panel 710 rotated around the hinged spine 714 to a second read position that is substantially orthogonal to the second panel 712. The antenna 702a of the first panel 710 emits a magnetic field that is oriented substantially perpendicular to a field emitted by a second antenna 716 embedded within a surface 718 of the second panel 712.

The panels 710, 712 described above are configured to produce a maximum magnetic field output from the antennas 702a, 716 while minimizing the far field emissions in a region near the reader system 700. In particular, since the panel 710 can be rotated relative to the panel 712, the field output from the respective antennas 702a, 716 is orientation-variable, and thus adjustable, to enable optimizing the emitted field. In this manner, the device RFID tags 60 are “readable” even if the case 404, or metal in a data storage device, interferes with the fields, or is less than optimally positioned relative to the reader system 700.

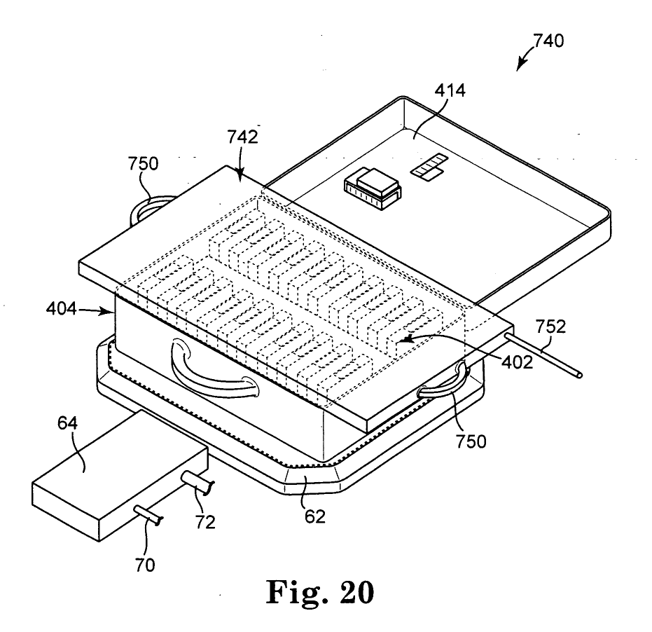

FIG. 20 illustrates a perspective view of a reader system 740 according to another embodiment of the present invention. The cover 414 of the case 404 is illustrated in the open position for descriptive purposes, although it is to be understood that in some embodiments the reader system 740 reads the device RFID tags 60 through a closed case 404.

The reader system 740 includes a portable antenna 742 in communication with the pad antenna 62a and the reader unit 64 of the reader system 54 illustrated in FIG. 1. The portable antenna 742 is sized to be manipulated by the user in providing a separate RFID field from an embedded antenna (not shown), for example, that compliments the field generated by the pad antenna 62, thus ensuring that all of the device RFID tags 60 enter into a read field of the reader system 740. The antenna within the portable antenna 742 is substantially similar to the antennas described above, including the antenna 62a (FIG. 1). In one embodiment, the portable antenna 742 has an antenna area of about 350 mm×390 mm, although other antenna sizes are also acceptable. The portable antenna 742 additionally includes handles 750 configured to be grasped by an operator, and includes an electrical connector 752 for electrical connection to the reader unit 64 and the GUI 66 (FIG. 1).

In the embodiments described above, the reader systems can employ separate read and write antennas. In this regard, multiple antennas may be used with a reader system, particularly to increase a read range without exceeding regulated electromagnetic field limits. Recall, in some jurisdictions government regulations specify limits for maximum electromagnetic field strength, and it can be desirable to have multiple (and less powerful) antennas that each are within the field guidelines where each antenna contributes to the read field of the reader system. In this regard, the multiple antennas used in the reader systems described above will increase the read range of the RFID reader without exceeding field limits.

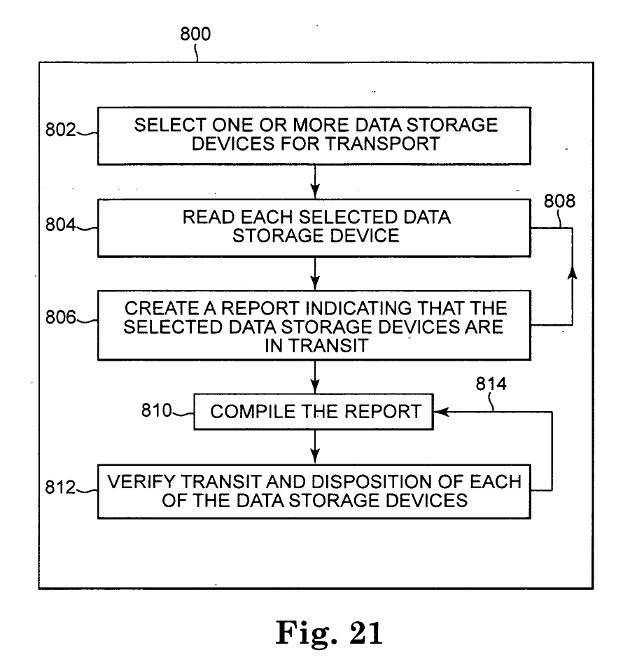

FIG. 21 illustrates a flow chart 800 of a process for tracing one or more data storage devices in transit according to one embodiment of the present invention. With additional reference to FIG. 11A, the flow chart 800 describes a process by which one or more data storage devices 402 are pulled or selected for transport from a facility, the data storage devices 402 are read by the reader system 54, the GUI 66 creates a report identifying which of the devices 402 have been selected for transit, and the GUI software (not shown) compiles a report and is operable to electronically verify transit and/or reception of the devices 402.

In particular, the flow chart 800 provides a process 802 for selecting one or more data storage devices for transport. In this regard, transport could include transit from a facility (such as backup devices leaving a business office for storage), or transit into a facility (such as backup devices returning to the business office from a secure storage site). Process 804 provides for reading (optically and/or electronically) each selected data storage device 402. It is to be understood that each device 402 includes the device RFID tag 60 described above. The reader system 54 is operable to RFID read/identify one or multiple of the devices 402 that are on or within a field that is generated by the pad antenna 62. In this manner, the unique 64 bit tag ID, the RFID revision field, the VOLSER number, the CRC check sum, the cartridge manufacturer's serial number, and/or any other user-defined field that is electronically stored on the chip 142 (FIG. 3A-3C) is simultaneously and individually read by the reader system 54.

Thereafter, the GUI 66 is operable to create a report that indicates the selected storage devices 402 are in transit, or scheduled for transit, or have been received, or are scheduled to be received. As a point of reference, the GUI 66 might create a report that indicates one or more of the devices 402 has not been correctly read, or has not been read at all. Loop 808 illustrates the use of the portable reader device 420 employed to selectively read and confirm the presence of one or more such devices 402.

After the report has been created by the GUI 66, a user is able to operate the GUI 66 to compile the report in process 810. In one embodiment, process 810 compiles the report and is operable to write a file electronically to the GUI 66 that is stored or transferred to other systems/networks. For example, in one embodiment the user employs the process 810 to compile a report in a spreadsheet application, or in a word processing application or other program suited for data processing. The report is file-shared with the originator of the devices 402 to inform the originator that the devices 402 are being traced. In this regard, the file-sharing can be network-based and/or sent automatically via the Internet, for example.

Process 812 provides for verifying transit and disposition of each of the data storage devices 402 identified in the compiled report. For example, in one embodiment the process 812 sends an e-mail to the user and to an intended recipient notifying each that the selected data storage devices have been scheduled for transit and are expected to arrive at the indicated/selected terminus at a projected time. Loop 814 provides for redundancy checking and the verification of the transit of the data storage devices 402 by double checking with the compiled report and process 810.

Flowchart 800 illustrates but one embodiment of the electronic data storage device tracing system 50 employed to identify and trace data storage devices. Those with skill in the art of data generation and protection will recognize that the systems described above are operable in any number of ways to sense/read/write RFID tags located within an electromagnetic field of an antenna, and trace and report on the tracing of the devices to which the tags are attached.

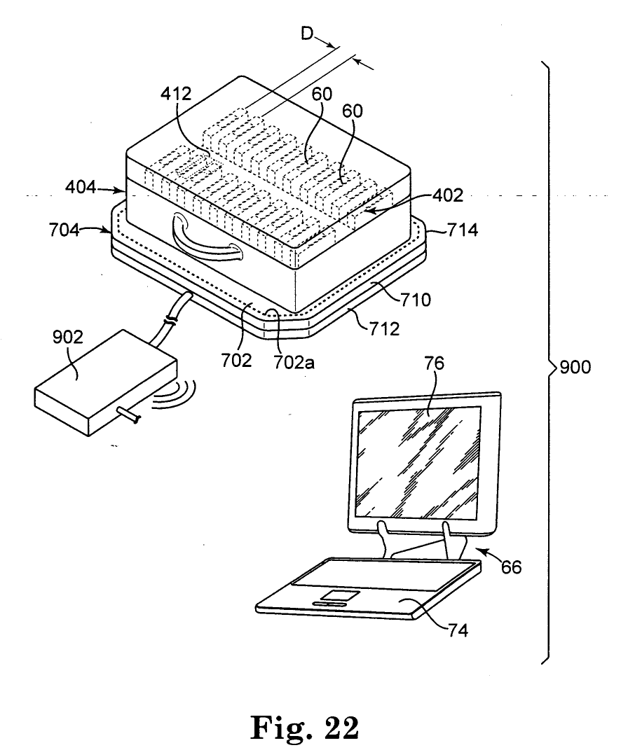

FIG. 22 illustrates a perspective view of another embodiment of an electronic data storage device tracing system 900. The tracing system 900 includes a reader unit 902 that communicates with the GUI 66. In one embodiment, the reader unit 902 communicates wirelessly with the GUI 66, although other forms of communication are also acceptable. The illustration shows the case 404 of data storage devices 402 positioned on the first antenna surface 702 of a flip antenna assembly 704, although other antenna configurations are also acceptable, such as any of the antenna configurations illustrated in FIGS. 17-20. The antenna assembly 704 is configured to communicate with all of the RFID tags placed on the data storage devices 402 and/or the case 404, and the reader unit 902 is configured to communicate data read from all of the devices 402 to the GUI 66, and, in particular, to a database of the GUI 66. In one embodiment, the reader unit 902 is configured to individually address and scan multiple RFID tags in one “pass” or scan independent of the host computer. In this manner, multiple RFID tags 60 are read and the data appended to the GUI 66 database in one scan, as opposed to addressing/scanning/reading each of the multiple RFID tags one at a time.

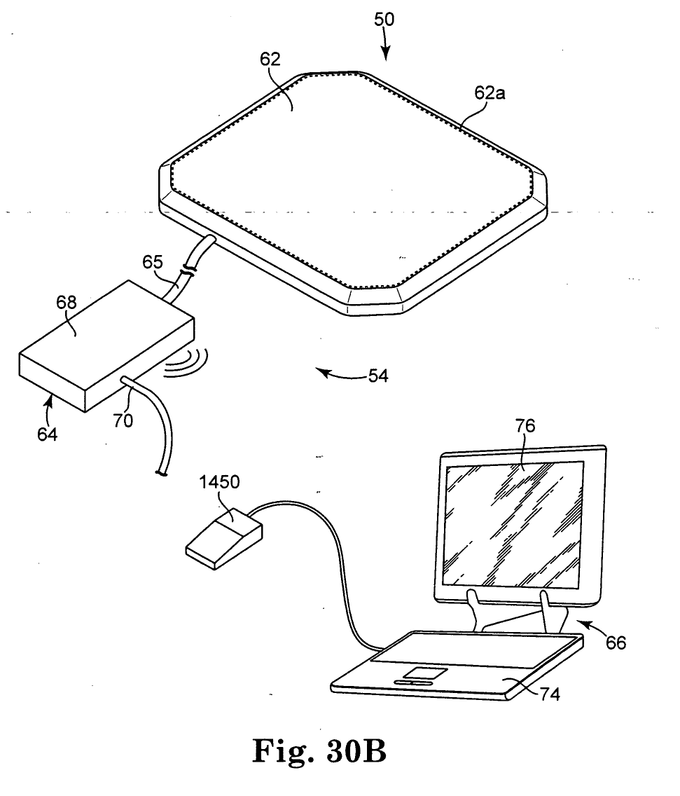

In one embodiment, the reader unit 902 communicates data read from the devices 402 and/or the case 404 to the database of the GUI 66 any time that the data storage devices 402 are within radio frequency range of the antenna surface 702. In another embodiment, the reader unit 902 communicates data read from the devices 402 to the database of the GUI 66 when prompted by a user command sent through the GUI 66. In preferred embodiments, the reader unit 902 communicates data read from the devices 402 to the database of the GUI 66 when the case 404 is placed on the antenna assembly 704 (as described in FIG. 30A) or when prompted by a user depressing a foot switch coupled to the antenna assembly 704 (as described in FIG. 30A).

The data storage devices 402 are generally stowed within the case 404 in a manner that protects the devices 402 during transportation and enables radio frequency reading of the stowed devices 402 and their respective RFID tags 60. With additional reference to FIGS. 12 and 14A, one embodiment provides for data storage devices 402 stowed within the case 404 such that each device 402 is spaced from another adjacent device 402 by a pitch represented by distance D. The distance D is generally taken as a distance from a centerline of one device 402 to a centerline of an adjacent device 402. In one embodiment, the distance D is less than 3 inches, preferably less than 2 inches, and more preferably the distance D is about 1 inch.

With additional reference to FIG. 3A and FIG. 4A, the device RFID tag 60 is preferably sized to be coupled to an external side of the housing section 114 (as opposed to either major top/bottom surface of the housing 56). Placement of the device RFID tag 60 onto the side of the housing 56 locates the label 58 for convenient viewing by a user, both during storage of the device and during insertion of the device into a drive assembly.

In one embodiment, the antenna 144 of the device RFID tags 60 accommodates placement on the external side of the housing section 114 and is sized to have a length L of generally greater than 25 mm and a width W of generally less than 10 mm such that the antenna area is in the range of between 200-2200 square millimeters and the antenna magnetic read field strength (in Amperes per meter) is less than 3 A/m rms. Preferably, the antenna 144 has an antenna area in the range of between 250-800 square millimeters and a magnetic field read strength of less than 2 A/m rms. One exemplary antenna 144 has an antenna area of about 518 square millimeters and a magnetic read field strength of about 0.7 A/m rms, although other antenna sizes having other read field strengths are also acceptable. Field strength in this specification is measured in A/m rms (root mean square), and not A/m pk or A/m pp.

A first exemplary embodiment of suitable dimensions for the antenna 144 includes a length L of 74 mm and a width W of 7 mm having a read field strength of 0.7 A/m. Another example of suitable dimensions for the antenna 144 includes a length L of 74 mm and a width W of 9 mm having a read field strength of 0.6 A/m. Another example of suitable dimensions for the antenna 144 includes a length L of 55 mm and a width W of 14 mm having a read field strength of 0.6 A/m. Another example of suitable dimensions for the antenna 144 includes a length L of 74 mm and a width W of 14 mm having a read field strength of 0.4 A/m. Another example of suitable dimensions for the antenna 144 include a length L of 55 mm and a width W of 7.3 mm having a read field strength of 0.7 A/m.

In general, the reader unit 902 is operable to read an identification number from the chip attached to the device RFID tags 60, and the GUI 66 is operable to append at least the identification number to a tracking database of the GUI 66 for each of the data storage devices 402 entering/exiting a facility.

In one embodiment, the reader unit 902 employs software, such as that described above for the reader unit 64, to determine the identification of the device RFID tags 60 that are within radio frequency range of the field generated by the antenna 702a, and the GUI software is employed to read identifying information, including encrypted information, between the device RFID tag 60 and the GUI 66. For example, during an initial inventory of the case 404, commands are sent to the RFID tags 60 (through the reader unit 902 as directed by the GUI 66), and each chip 142 responds with its identification number. Subsequently, each device 402 is individually addressed by identification number, and each device RFID tag 60 responds with a string of device data including the device 402 VOLSER number, a check sum of the VOLSER number, and/or data for decoding an encrypted VOLSER number.

Generally, software operable by the reader unit 902 is employed to read information from the device RFID tag 60, and software of the GUI 66 accesses the information read by the reader unit 902 and appends this information to the GUI 66 database. In this manner, all of the contents of the case 404 can be scanned quickly (e.g., in one scan) and accurately. In addition, the identifying device data (e.g., a VOLSER number or other number, such as a unique cartridge identifying number supplied by the cartridge manufacturer) need not be written into the memory of the device RFID tag 60 but is instead appended to the database or otherwise associated with the GUI database, as described below.

With additional reference to FIG. 3A, one embodiment provides memory chip 142 of the device RFID tag 60 to be in conformance with the industry standard ISO 15693. In this regard, the chip 142 includes a unique 64 bit identifier (i.e., a chip identifier) that is written to the chip by the manufacturer. Once written, this unique 64 bit chip identifier is constant and cannot be modified. Other forms of chip identifiers, including other bit sizes, are also acceptable.

In one embodiment, the reader unit 902 is employed to read the chip identifier from chip 142 of the device RFID tag 60, and the GUI 66 uploads the chip identifier information and appends this information to the GUI 66 database. In this regard, identification of each device by its identifying RFID tag 60 is efficient and the scan is relatively fast compared to optical scans and/or operator assisted scans. In one embodiment, the GUI 66 is operable to append each chip identifier for each of the multiple data storage devices 402 to the database in less than about 5 seconds, preferably in less than about 3 seconds, and more preferably the GUI 66 is operable to append each chip identifier for each of the multiple data storage devices 402 to the database in a time frame of between about 0.5 to 5 seconds.

One embodiment provides for scanning the devices 402, reading both the VOLSER number on the device 402 and the unique 64 bit identifier, and sending these numbers to the tracking database of the GUI 66. Consequently, a particular device 402 can be individually specified/recognized by the system 900 and the risk of possible duplication of VOLSER numbers (or confusion with other VOLSER numbers of other of the devices 402) is eliminated since the 64 bit identifier is unique to each device 402. That is to say, even if the VOLSER number is non-unique (i.e., a duplicated VOLSER number or duplicated device data), reading both the VOLSER number on the device 402 and the unique 64 bit identifier results in a unique identification of the device since each VOLSER number is associated with the unique 64 bit identifier of the RFID tag 60.

In one embodiment, the GUI 66 is operable to append a VOLSER number and a chip identifier for each of the multiple data storage devices 402 to the database in less than about 10 seconds, preferably in less than about 6 seconds, and more preferably the GUI 66 is operable to append the VOLSER and the chip identifier for each of the multiple data storage devices 402 to the database in a time frame of between about 1-6 seconds.

In one embodiment, the unique 64 bit identifier is combined with the VOLSER number as a single identifier within the GUI 66 database (the single large identifier is thus unique since 64 bit identifier portion is unique). In other embodiments, the unique 64 bit identifier is a separate field within the GUI 66 database and is only referred to when an identification conflict arises, such as when more than one VOLSER number is located and the unique 64 bit identifier is employed to resolve the conflict (i.e., identify the specific cartridge).

With the above in mind, one embodiment provides the GUI 66 database configured to recognize an identifying portion of the VOLSER number, for example, a serial number of the VOLSER, where the database is configured to associate the identifying portion of the VOLSER number with a unique manufacturer identifier assigned (i.e., electronically stored) to the memory chip of the device RFID tag 60. This approach provides one embodiment for avoiding a duplication of VOLSER numbers on data devices by associating the unique device RFID tag 60 identifier with whatever VOLSER number happens to be provided on any particular device.

Embodiments provide for the GUI 66 to wirelessly append information read by the reader unit 64 into the database of the GUI. In this manner, a user of the system 900 experiences seamless file sharing between the database software and the software of the GUI 66, which is useful in the tracing of the data storage device 52 via the device RFID tag 60.

Embodiments described above provide for scanning multiple data storage devices 402 in a device tracking and tracing system 50, 900 as the devices 402 are transported. Certain large asset tracking systems employ thousands of devices that are traced and tracked within a facility. Embodiments described below provide another system that minimizes human interaction and enables the tracking and tracing of many multiple individual data storage devices.

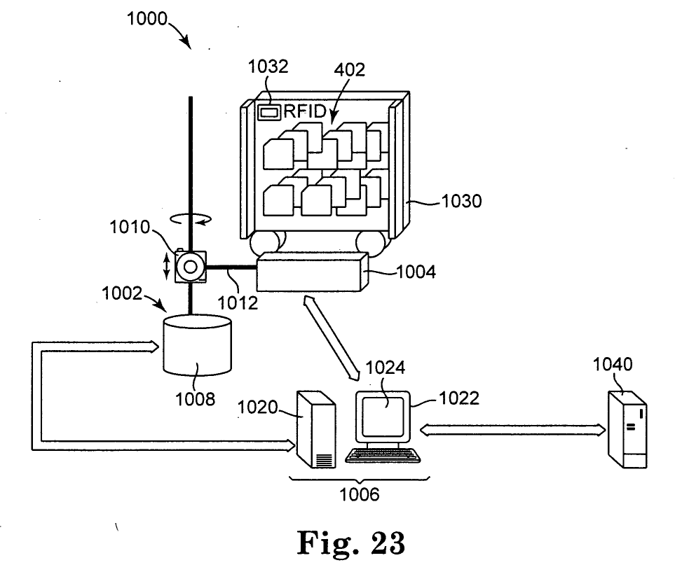

FIG. 23 is a simplified diagrammatic view of a data storage tracing system 1000 according to one embodiment of the present invention. System 1000 includes a robot 1002, an RFID scanner 1004 coupled to the robot 1002, and a user interface 1006 in communication with the scanner 1004. In one embodiment, the robot 1002 includes a controller system 1008 that controls movement of a robotic arm 1010 and an end effector 1012 extending from the arm 1010, where the scanner 1004 is coupled to the end effector 1012. The robot 1002 includes any of the mechanisms configured to move in response to commands from a controller. One example of a suitable controller system 1008 for robot 1002 includes a Robot-RC controller system available from Innovation First, Inc., Greenville, Tex.

The robotic arm 1010 includes a motor controller that enables the arm 1010 to move through at least one degree of freedom (for example, the arm 1010 moves up-down). Alternatively, the arm 1010 moves through two degrees of freedom (for example, the arm 1010 moves up-down and rotates). In one embodiment, the robotic arm 1010 is configured for movement in three axes (i.e., the arm 1010 has three degrees of freedom) such that the scanner 1004 that is coupled to end effector 1012 may be selectively positioned at any point in an XYZ coordinate system and usefully employed to scan multiple data storage devices. One suitable motor controller includes the Victor 885 motor controller available from Innovation First, Inc., Greenville, Tex.

The scanner 1004 is similar to the reader unit 64 (FIG. 1) and the reader unit 902 (FIG. 22) and includes a reader unit available from Feig Electronics, Weilburg, Germany, although other suitable reader units and scanner systems are also acceptable. In general, the scanner 1004 includes an RF antenna and is configured to communicate with the user interface 1006, either wirelessly or over an electrical connector. The user interface 1006 generally includes a computer 1020 in communication with a monitor 1022 having a screen 1024.

In one embodiment, a trolley 1030 including multiple data storage devices 402 is placed near the robot 1002. The trolley 1030 generally includes doors that open/close and is configured to contain hundreds of data storage devices 402. One embodiment provides a wheeled trolley 1030 configured to contain about 480 devices 402, although other sizes and shapes of trolley 1030 are also acceptable. The robot arm 1010 moves up-down and angularly, and the end effector 1012 moves in-out to enable the scanner 1004 to scan all data storage devices 402 in the trolley 1030.

During a scan, the trolley 1030 is placed near the robot 1002. The multi-degree of freedom robotic arm 1010 and the end effector 1012 move relative to the trolley 1030 in scanning information from each of the data storage devices 402. The scanned information is communicated to the user interface 1006 for storage in an electronic database. In one embodiment, a server 1040 is optionally provided and the data of the user interface 1006 can be communicated to the server 1040 for communication across a network, for example.

In a manner similar to FIG. 1A above, the trolley 1030 can include a cart RFID tag 1032. The cart RFID tag 1032 is programmed with information related to the multiple data storage devices 402 contained within the trolley 1030. In this regard, the trolley 1030 is termed a “parent” and the devices 402 in the trolley 1030 are termed “children.” The RFID tag 1032 enables tracking and tracing of the parent trolley 1030, and includes information that enables tracing of the children data storage devices as they move with the parent trolley 1030. For example, the RFID tag 1032 is programmed to identify each device 402 within the parent trolley 1030, such that tracking and tracing the trolley 1030 also tracks and traces each data storage device 402 within the parent trolley 1030. In this manner, many hundreds of data storage devices 402 (i.e., “assets”) are traceable within a facility, or traceable entering/exiting a facility.

Although a wheeled trolley 1030 is illustrated in FIG. 23, other storage containers for transporting multiple data storage devices 402 are also acceptable, including the case 404 (FIG. 22). Embodiments of the system 1000 provide for simultaneously scanning multiple RFID enabled data storage devices 402 within seconds, and in a manner that reduces human interaction that can introduce error into the scanning process. In one embodiment, the user interface 1006 is operable to append the VOLSER number and the identification number for each of about 480 multiple data storage devices to the database in a time frame of between about 1 to 5 minutes. In contrast, other systems, such as optical-only systems, require the individual scanning of each device on the trolley one device at a time, which is a time-consuming process that could require an hour or more to complete the scan.

When scanning multiple data storage devices in one scan, it can be difficult to determine when one RFID tag is not read. An RFID tag is not read in the case where the RFID tag does not respond to the scanner 1004. The failure to read all device tags in a shipment can lead to certain RFID enabled items being included in a shipment that were not intended for shipment. In addition, these failures to read can be time-consuming and costly as an operator of the system diverts attention to reconciling the shipping list with the physical inventory list. For example, if the RFID tag that is not read is a case tag, the expected association between the case and its contents will not be inferred by the database of the user interface, and the case will not be included in the shipping list. Therefore, it is desirable for a tracing and tracking system to be able to specify to the user interface how many items are expected to be scanned and whether or not an RFID case tag is expected to be present. Embodiments of system 1000 provide for specifying the expected RFID scan conditions and provide for an alert to an operator when the scan conditions are not met.

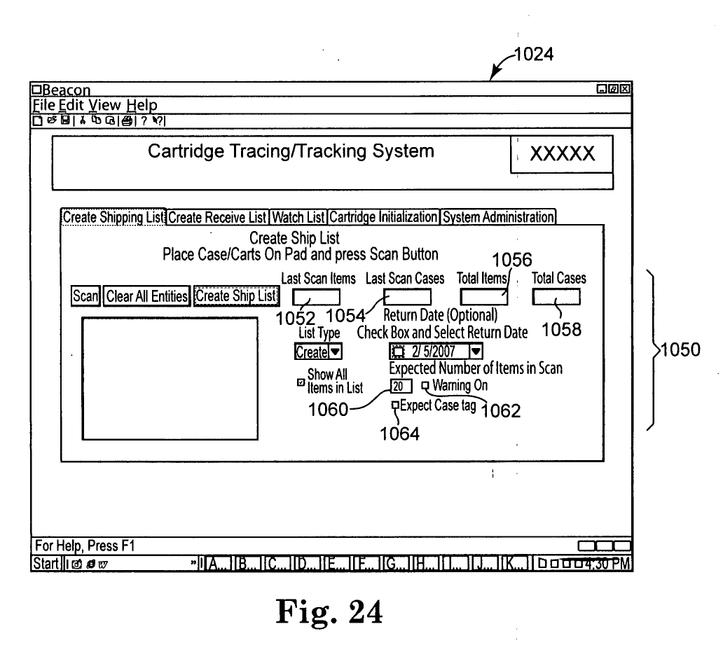

FIG. 24 illustrates one embodiment of a tracing system screen 1024 including interactive fields 1050 that monitor expected RFID scan conditions. The fields 1050 include a field 1052 for the number of items found in the last scan, a field 1054 related to the number of RFID case tags located, a field 1056 for the total number of items scanned, and a field 1058 for the total number of cases located. All fields are available for interaction/manipulation by an operator.

In one example, the operator looks at the fields 1050 to determine if the shipping list correlates with the physical inventory list. Although this approach is effective, it is desired to minimize the operator interaction with the screen 1024. In this regard, one embodiment provides a field 1060 programmed in the GUI 66 that includes the expected number of items for any scan. If an RFID scan is initiated and the expected number of items indicated by field 1060 is not found, an audible alert is sounded and a visual blocking dialog box is presented to the operator. The operator must acknowledge the dialog box before operations continue. In this manner, the operator is not “tied” to the screen 1024, operator interaction is minimized (and the potential for operator-induced error is reduced), and the operator is provided with immediate feedback if an expected item is missed by a scan.

A checkbox 1062 is provided to toggle the alarm feature between activated and de-activated states. Similarly, a field 1064 is provided in which it can be specified whether a case tag is expected during a scan. With the above in mind, the data screen 1024 ensures that the shipping list matches the physical inventory list, which frees the operator to concentrate on other tasks, and audible and visual alarms are provided through user interface 1006 to alert the operator as needed to anomalous, or unmet, conditions.

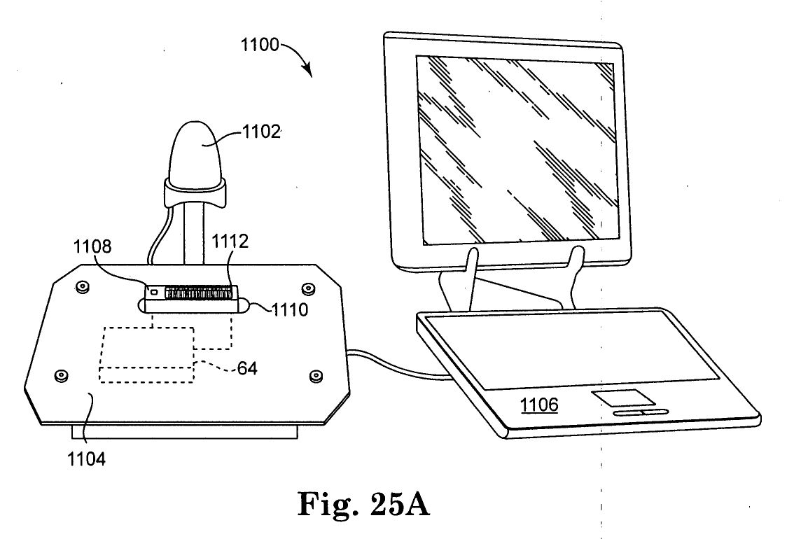

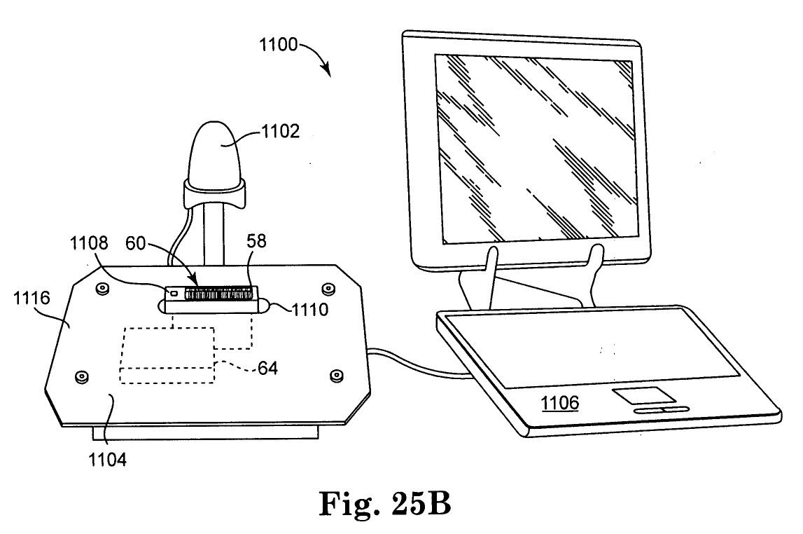

FIG. 25A illustrates a perspective view of a label replacement workflow station 1100 according to one embodiment. Workflow station 1100 includes an optical scanner 1102, an RFID reader station 1104, and a user interface 1106 in communication with scanner 1102 and reader station 1104. Generally, users of systems 50, 400, 900 may find it desirable to update or otherwise retrofit existing (“old”) data storage devices with new RFID enabled labels. Workflow station 1100 provides for updating an existing VOLSER label attached to a data storage device with an RFID enabled label 60 that is cross-referenced to contain the “old” VOLSER label data and provides a unique electronically stored identification number useful in tracing data devices.

In an exemplary embodiment, a data storage device 1108 is inserted into an opening 1110 formed in the reader station 1104 such that a printed label 1112 attached to the device 1108 is oriented toward the optical scanner 1102. The optical scanner 1102 is operable to read the data and information on the label 1112 and communicate this information to the user interface 1106. In one embodiment, the data storage device 1108 is an existing in-service device, and the label 1112 is an old label that includes information related to the device 1108. A user/customer has an interest in continuing to refer to (i.e., address) the existing device by its label information in a more efficient RFID-enabled manner. Workflow station 1100 provides for replacing the old label 1112 with a new RFID enabled label 60 to convert the data storage device 1108 to an RFID enabled device 1108, as shown in FIG. 25B.

FIG. 25B illustrates data storage device 1108 updated and converted to include the RFID enabling label 60. The RFID reader unit 64 is coupled to the reader station 1104. It is desirable to orient the RFID enabled label 60 parallel to the reader station 1104 (and in particular, parallel to the RFID reader unit 64). To this end, the opening 1110 is formed in the reader station 1104 such that when the cartridge 1108 is inserted into the opening 1110, the RFID label 60 is substantially parallel to the work station 1104 and the reader unit 64 (although not necessarily in the same plane). The RFID enabled label 60 includes the optical label 58 (FIG. 2) that is suitable for scanning by the scanner 1102 and suited for initialization with the information taken from the old label 1112.

Embodiments provide scanning the optical data from the old label 1112, removing the old label 1112, and applying the new RFID enabled label 60 onto the data storage device 1108. The workflow station 1100 is operable to save the scanned information from the old label 1112, and initialize information to the new label 60 through interaction with the user interface 1106.

Other embodiments provide scanning an existing RFID enabled label, removing the old RFID enabled label, and applying a new RFID enabled label onto the data storage device 1108.

In one embodiment, the optical scanner 1102 is any suitable optical scanner configured for reading bar code and other data from optical labels. In one embodiment, the optical scanner 1102 includes one of the MS-series of scanners available from MICROSCAN, Renton, Wash. Other suitable optical scanners are also acceptable. In one embodiment, the RFID station 1104 includes an opaque work surface 1116 having the RFID reader unit 64 attached or otherwise disposed adjacent to the surface 1116. In one embodiment, the user interface 1106 includes a computer, such as a laptop computer, that is configured to store, sort, and share electronic data. Other suitable user interfaces having memory and data communication ports are also acceptable.

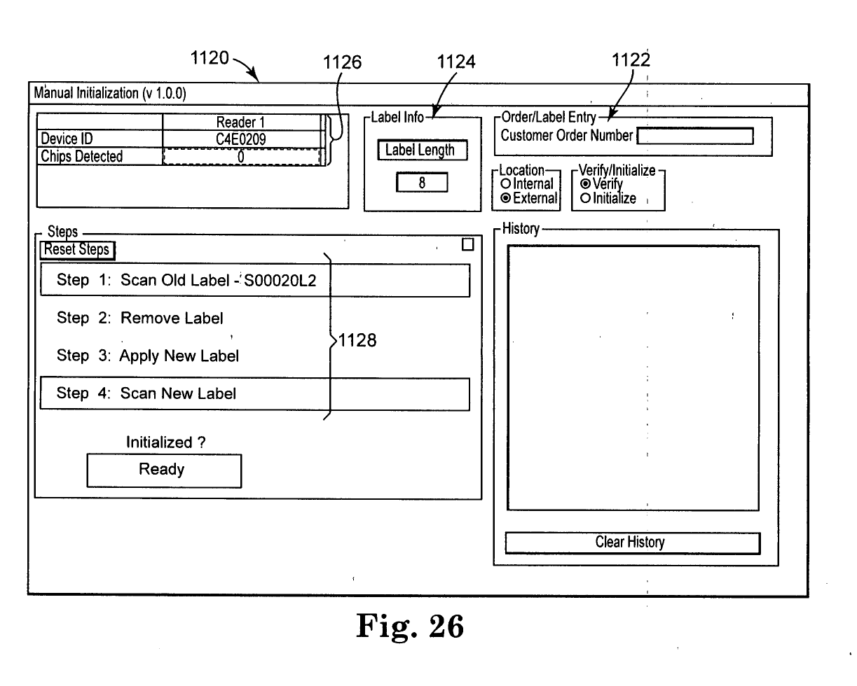

FIG. 26 illustrates a screen shot of the user interface 1106 (FIG. 25B). Screen shot 1120 includes a variety of data fields including a customer field 1122, a label field 1124, an RFID field 1126, and an operator workflow field 1128. Field 1122 tracks customer order information. Field 1124 monitors label information related to label length and whether the label 58 has been positioned within the field of the scanner 1102 (FIG. 25B). Field 1126 monitors whether the RFID chip on the RFID enabled label 60 is detected. The operator workflow in field 1128 includes provisions for scanning an old label, removing an old label, applying a new RFID enabled label, and scanning the new RFID enabled label with the scanner 1102 and reading the RFID enabled label 60 with the reader unit 64. This information is configured for saving into a database of the user interface 1106. In one embodiment, information stored on the user interface is suited for transmission to a network or suited for saving to a portable memory device coupled with user interface 1106. With this in mind, the scanner 1102 and the reader unit 64 communicate with the user interface 1106 electrically, although wireless communication is also acceptable.

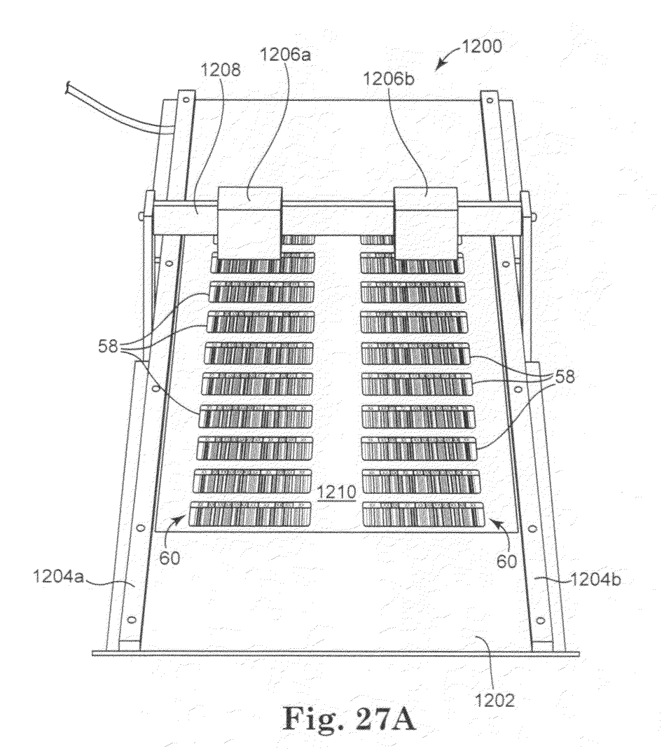

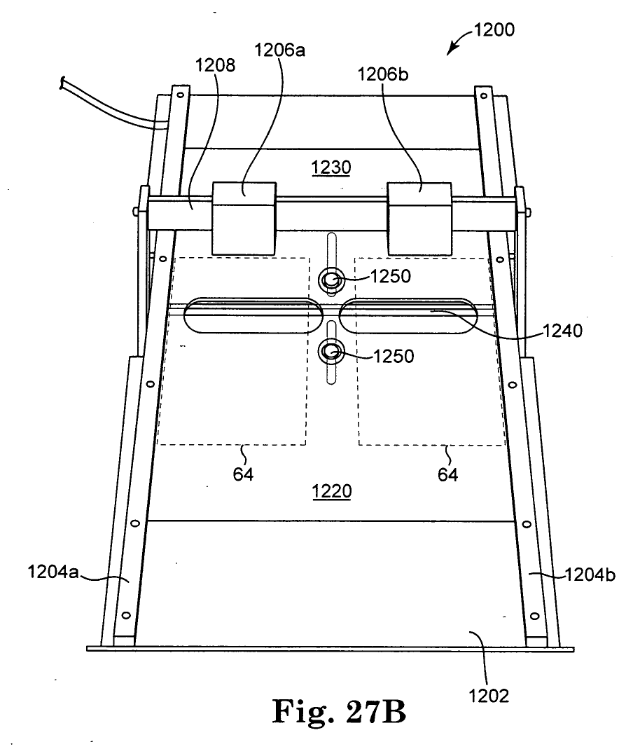

FIG. 27A illustrates a perspective view of an RFID VOLSER label initialization station 1200 according to one embodiment. The label initialization station (LIS) 1200 communicates with a computer/user interface includes a work surface 1202 having guides 1204a, 1204b and multiple scanners 1206a, 1206b maintained in a fixed orientation above and offset from the work surface 1202. In one embodiment, a support 1208 is coupled to the work surface 1202, and the scanner 1206a, 1206b are coupled to the support 1208. During label initialization, label stock 1210 provided with multiple columns of RFID enabled labels 60 is disposed on the work surface 1202 such that a column of labels 60 is aligned with a first one of the optical scanners 1206a, and another column of labels 60 is aligned under a separate optical scanner 1206b.

Embodiments provide for multiple columns of RFID enabled labels 60, with each column of labels 60 having a corresponding optical scanner 1206 positioned to read the labels 60, and a corresponding RFID reader unit 64 (FIG. 27B) positioned to RFID scan the labels 60. The label stock 1210 is configured to move along the work surface 1202 between the guides 1204a, 1204b to enable the scanners 1206a, 1206b to read VOLSER labels 58 and enable reader units 64 to initialize each in the column of labels 60.

FIG. 27B illustrates the LIS 1200 with the label stock 1210 (FIG. 27A) removed. The optical scanners 1206a, 1206b are positioned above the work surface 1202, and an opposing pair of RFID reader units 64 are located under the work surface 1202 and aligned with a respective one of the optical scanners 1206a, 1206b.

The reader units 64 are configured to read any RFID enabled label within radio frequency range. However, the optical scanners 1206a, 1206b are configured to read only those optical labels that are directly in view of (i.e., underneath) the scanning field. With this in mind, it is desirable to limit the RFID read range of the reader units 64 to only those RFID enabled labels 60 that are immediately between the reader unit 64 and the optical scanners 1206a, 1206b.

Embodiments of the LIS 1200 provide a first plate 1220 and a second plate 1230 separated by a distance to define a window 1240 between plates 1220, 1230. The plates are formed of material that impedes radio frequency transmission, such as metal. Adjustment mechanism 1250 is provided to adjust the window 1240 size between plate 1220 and plate 1230 to achieve RF reading of that row of RFID labels 60 immediately over (aligned) with the window 1240. When so adjusted, the plates 1220, 1230 block RFID reading of the tags 60 except in the area of the “open” window 1240.

In one embodiment, the plates 1220, 1230 are provided separately from the work surface 1202 and the guides 1204a, 1204b are removably coupled to the work surface 1202. Another embodiment provides for the work surface 1202 to be defined by the plates 1220, 1230 having the window 1240 formed there between. In any regard, the plates 1220, 1230 impede the reader unit 64 from reading all RFID tags within range, and limit the reader unit 64 to reading only those RFID enabled tags 60 in the window 1240. It is desirable, then, to align the window 1240 with the optical scanners 1206a, 1206b to enable the scanners 1206 to read the optical label 58 that are positioned for reading by the RFID reader units 64.

In one embodiment, the optical scanners 1206 are MS-3 optical scanners available from MICROSCAN, Renton, Wash. The reader units 64 are similar to the reader units described above and are available from Feig Electronics, Weilburg, Germany. The LIS 1200 is configured for communication with a user interface, such as the user interface 1106 (FIG. 25B).

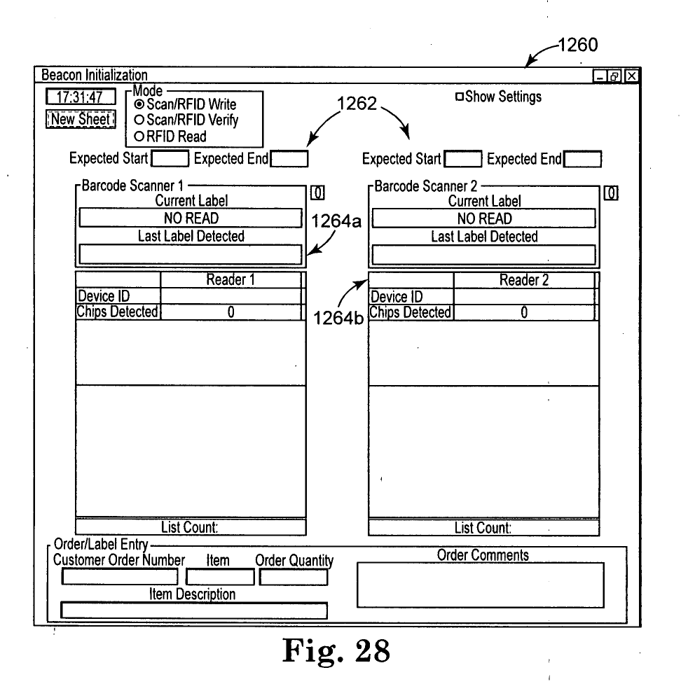

FIG. 28 illustrates a screen shot 1260 as it would appear on a user interface coupled to LIS 1200. Suitable user interfaces include those described above, including GUI 66 (FIG. 1) and the user interface 1106 (FIG. 25B). The screen shot 1260 of the user interface provides multiple data fields 1262 arranged in columns 1264a, 1264b. Each of the columns 1264a, 1264b includes data fields for the optical scanner 1206 and the RFID reader unit 64. Software of the user interface represented by the screen shot 1260 monitors that the data read in the optical and RFID scans been written, verified, started and ended, providing a list count of tags verified by customer order number and order quantity. Those of skill in the art will recognize that the screen shot 1260 could provide other data depending upon the software implemented by the user interface/LIS 1200.

The reader systems described above include read antennas (alone or in an antenna pad) that are sized to balance the power/range of the antenna with the emitted field of the antenna. In general, the antenna bandwidth is inversely proportional to the quality factor Q. In this regard, certain antenna dimensions are selected to minimize the far field emissions at maximum antenna output, optimize the antenna quality factor Q, and minimize reader power.

The antennas described above, including antenna 62a, 702a, and 716 are all configured to minimize far field emissions and maximize antenna output. Although each of the antennas 62a, 702a, 716 has achieved this balance in slightly different ways, certain antenna configurations are optimal for RFID scanning of a case of multiple data storage devices, such as the case 404 above. With this in mind, one embodiment of an optimized reader antenna 1300 is described below.

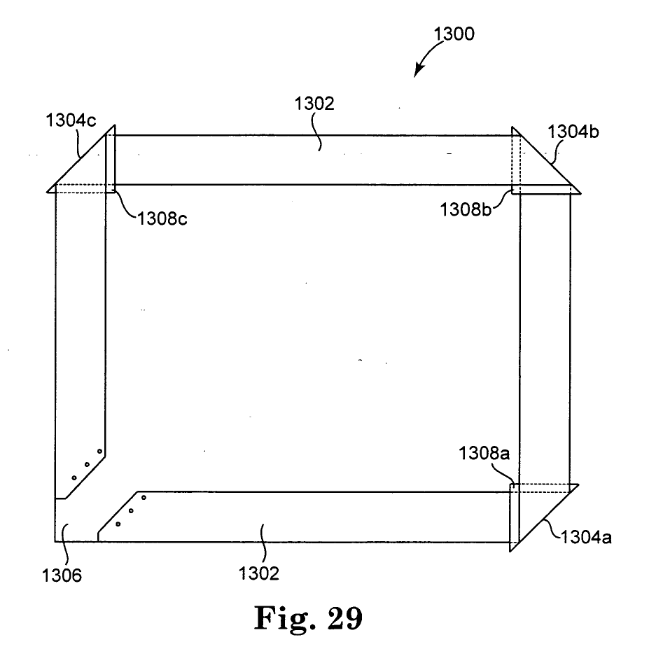

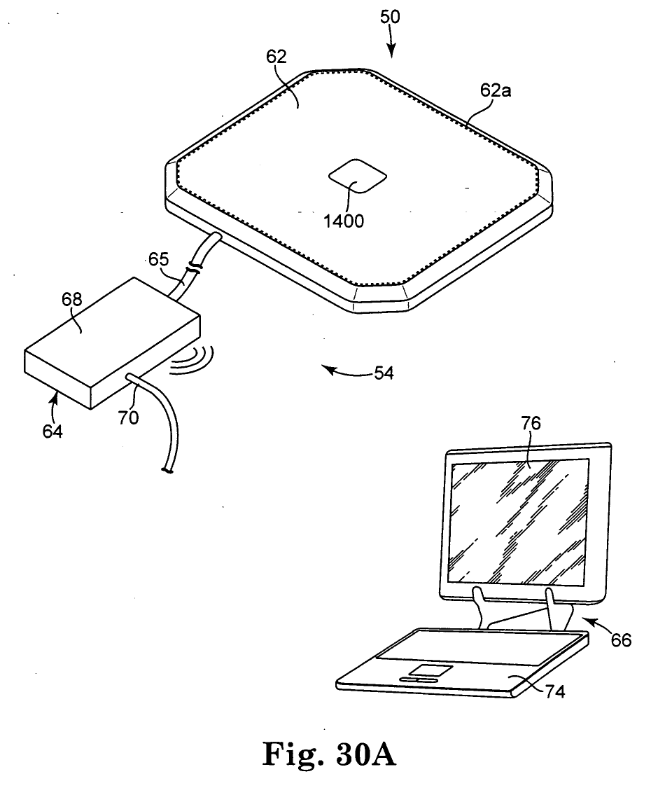

FIG. 29 illustrates a top diagrammatic view of an RFID reader antenna 1300 according to one embodiment. The antenna 1300 includes a continuous antenna ribbon 1302 folded at corners 1304a, 1304b, 1304c to define a generally rectangular shape having ends that terminate at an antenna tuning circuit board 1306. In one embodiment, the antenna ribbon 1302 is provided as a continuous copper strand having dimensions of about 50 mm×0.08 mm×1740 mm that is folded onto itself at the corners 1304a, 1304b, 1304c to define a conductor having a generally rectangular shape. In one embodiment, optional insulators 1308a, 1308b, 1308c are provided, one at each of the respective corners 1304a, 1304b, 1304c, to minimize the possibility of a variation in antenna inductance due to the overlapping contact that might negatively affect the performance of the antenna 1300.

The antenna ribbon 1302 provides a conductor that is generally wider than it is thick. The antenna ribbon 1302 is about 50 mm wide, which is substantially wider than conductors employed in RFID antennas of comparable size. In this regard, the comparatively wider antenna ribbon 1302 provides a conductor having a lower inductance, which enables the antenna 1300 to have a lower quality factor Q. These factors combine to enable the antenna 1300 to be more stable during radio frequency reading of RFID tags (i.e., the tuning loss of antenna 1300 is less sensitive to nearby metal objects). The relatively wide antenna ribbon 1302 provides a larger perimeter for current to flow through as compared to round and rectangular conductors employed in other RFID antennas of comparable size.

With additional reference to FIG. 11C and Table 1, one embodiment of the reader antenna 1300 provides a generally rectangular conductor having a width of between about 0.22-0.60 m and a length of between about 0.4-0.8 m, and preferably a width of about 370 mm X a length of about 500 mm on center. Under the convention established by Table 1, the X1, Y1 corner or half-size dimensions of the reader antenna 1300 is 0.25 m, 0.185 m in one embodiment. In one embodiment, the antenna 1300 is characterized by a quality factor Q of about 15 and an antenna inductance of about 1.10H, and operates at a current of about 1.3 amps (RMS), although other operating currents are also acceptable. The antenna 1300 is configured to rapidly read multiple high frequency RFID tags 60 attached to the data storage devices 402 and the case 404 (FIG. 19A). The antenna 1300 has a desirably low Q factor, so the impedance is matched over a broader operating range, resulting in a more efficient operating field, having less sensitivity to internal and external variations, and has a broader receive bandwidth for receiving the response from the RFID tags.

As a comparison, one commercially available antenna formed of a round 17 mm diameter conductor to an approximate size of 600 mm×800 mm has an antenna inductance of about 2.3 μH, and a higher and less desirable Q factor of about 32. Another known antenna formed from a copper strip having a width of 51 mm to an antenna size of 605 mm×1050 mm has an antenna inductance of about 2.3 μH, and a higher and less desirable Q factor of about 26.

FIG. 30A illustrates a perspective view of the electronic data storage device tracing system 50 where the reader system 54 includes a scan switch 1400. For reasons related to power consumption and near field radio frequency emissions, it is not desirable to employ pad 62 to continuously scan for data storage devices or cases containing data storage devices. Less power is consumed and radio frequency emissions are minimized when the reader system 54 selectively scans only when a data storage device or case of data storage devices is present on pad 62. With this in mind, one embodiment of the reader system 54 includes the scan switch 1400 that is configured to sense when a data storage device or case of data storage devices is present on the antenna pad 62.

In one embodiment, the scan switch 1400 includes a pressure sensitive switch configured to sense when a device or multiple devices are placed on the antenna pad 62. When the scan switch 1400 senses that one or more data storage devices are present on the antenna pad 62, the scan switch 1400 initiates the antenna 62a (i.e., enables energizing of the antenna 62a) to conduct a RFID scan. The reader unit 64 triggers the scan and communicates the information to the GUI 66.

The scan switch 1400 includes any electronic or mechanical switching means configured to sense the presence of one or more data storage devices. In one embodiment, the scan switch 1400 includes a real-time piezoresistive pressure sensing switch such as a Tactilus® sensing switch available from Sensor Products Inc., Madison, N.J. Other suitable pressure sensing switches are also acceptable. In another embodiment, the scan switch 1400 includes a light emitting diode emitter/receiver pair configured to initiate the antenna 62a to an on condition when one or more data storage devices is present on the antenna pad 62.

Embodiments of the scan switch 1400 provide for the automated selective scanning of data storage devices present on the antenna pad 62. In this regard, the scan switch 1400 solves the problems related to multi-step processing of an RFID scan. Some multi-step RFID scans necessitate operator input of one or more key strokes to a keyboard to initiate and terminate the scan. Embodiments of the scan switch 1400 automate this process, decoupling the operator from the scan sequence, in a manner that minimizes power consumption and radio frequency emissions from the antenna 62a.

FIG. 30B illustrates a perspective view of the reader system 54 including a foot switch 1450 configured to initiate an RFID scan of data storage devices on or near the antenna 62a. The foot switch 1450 is operable by a user to selectively energize the antenna 62a when the data storage device(s) is/are positioned for reading. In this manner, power consumption by the antenna 62a and its field of radio frequency emissions are desirably minimized by limiting antenna 62a power to only the few seconds during a scan.

The foot switch 1450 is illustrated as electrically connected to the memory unit (computer) 74. Those of skill in the switch art will recognize that the foot switch 1450 could be wirelessly coupled to the memory unit 74. One suitable foot-activated switch is a T-91 foot switch available from Linemaster Switch Corporation, Woodstock, Conn. Other suitable foot-activated switches, including wireless foot-activated switches, are also acceptable.

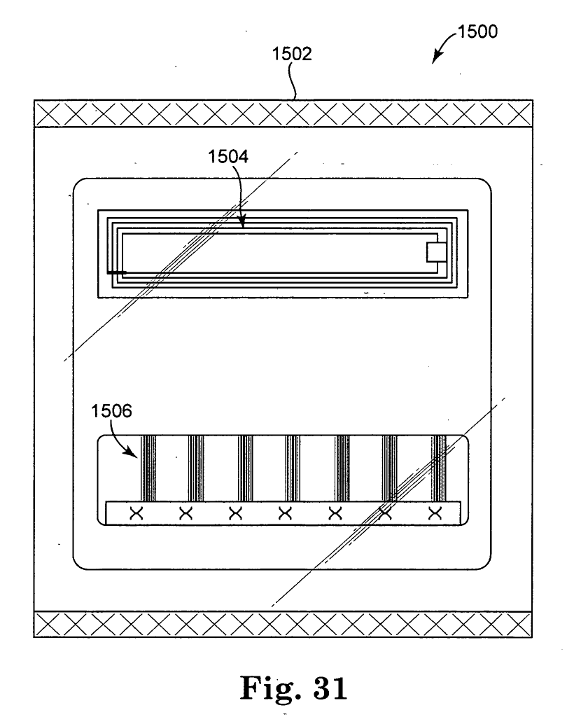

FIG. 31 illustrates a perspective view of a kit of parts 1500 according to one embodiment. The kit of parts 1500 includes a package 1502 containing an RFID tag 1504 and a label 1506. The RFID tag 1504 is similar to the RFID tag 60 described above and includes circuitry having a memory chip and an antenna. The label 1506 is similar to the label 58 described above and includes optical fields, such as bar code scannable fields and a VOLSER number. The kit of parts 1500 is suited for delivery to a customer who desires to provide a data storage device with an RFID enabled label. In this regard, the RFID tag 1504 is configured for attachment to an existing data storage device, and the label 1506 is likewise configured for attachment to the same data storage device. As described above, the RFID tag 1504 is attachable to a housing of a data storage device, and the label 1506 is attachable either over the RFID tag 1504, or adjacent to the RFID tag 1504 onto the housing of the cartridge. In this regard, the antenna of the RFID tag 1504 preferably has a length greater than about 35 mm, a width less than about 15 mm, preferably the width is less than about 10 mm, and a field strength of less than about 2 A/m, preferably less than about 1 A/m.

In one embodiment, the package 1502 is a sealed package that is opened for removal of the RFID tag 1504 and the label 1506. The tag 1504 and the label 1506 are suited for attachment to a data storage device. In one embodiment, the label 1506 includes optically readable data, such as the VOLSER number described above, and the tag 1504 is configured to be written, enabled, or otherwise initialized with at least the optical data on the label 1506, and preferably written to be associated uniquely to the device to which the tag 1504 is attached. In this regard, one embodiment provides for the kit of parts 1500 to be employed with the workflow station 1100 (FIG. 25B) in creating an RFID enabled data storage device.

In one embodiment, the tag 1504 is an RFID tag and the label 1506 is a printed label that are coupled together to define a device tag (similar to device tag 60 above) suited for attachment to a data storage device. In one embodiment, the label 1506 defines an area that is greater than an area of the RFID tag 1504 (see FIG. 3A), and the label 1504 is configured to be coupled to an end of the housing of the data storage device.

Other embodiments provide for pre-initialization and pre-RFID-enabling of the contents of the package 1502 in accordance with specifications placed in a customer order. For example, it is desirable to offer data storage device customers the ability to retrofit their existing devices to the style of RFID-enabled devices described above. To this end, the customer is provided with the means to place an order (e.g., through an Internet web-based ordering site) specifying the serial numbers of the cartridges they wish to RFID-enable, and a separate kit of parts 1500 is provided to the customer that enables the customer to uniquely identify their devices in a manner that is traceable within any of the electronic data storage device tracing systems described above.

Embodiments of the electronic data storage device tracing systems described above provide for the identification of multiple data storage devices in a single scan, where the single scan associates an identification number for each of the devices in a manner that enables tracing each data storage device in transit relative to the scanner. The scanner and the antenna associated with the scanner may be provided in multiple configurations. One embodiment provides a robotic scanner configured to scan hundreds of data storage devices on a trolley cart as the data storage devices are in transit between facilities, or in transit from one location in a facility to another location in that same facility.

Tracing multiple data storage devices is preferably done in an automated manner that minimizes operator input (and thus minimizes the potential risk of operator error). With this in mind, embodiments provide for software operable by a user interface of the system that is configured to create a shipping list of devices in transit, configured to track of the total items scanned, the total number of cases under the scan, and provides for alarms to the operator when the expected number of items in the scan do not match the number of items placed near the scanner antenna.

Other embodiments provide a workflow station for the optical scanning of existing optical labels, and the initialization of new RFID-enabled labels that include the scanned optical information from the old label. Other embodiments provide an initialization work station that is configured to initialize RFID tags with optically scannable data visible on a label portion of the tag.

Other embodiments of the system provide for a reader antenna including a highly efficient ribbon conductor having lower inductance and less sensitivity to variations in the environment near the antenna. The antenna includes a conductor that is generally wider than round and rectangular conductors commonly used in antennas, and provides a larger surface area (and perimeter) for increased current flow.

Other embodiments provide for automated reading by the reader antenna through the use of sensing devices. One sensing device includes a pressure sensitive device that activates the reader antenna when one or more data storage devices is placed on a pad of the reader antenna. Other sensing devices include foot activated switches, or light emitter/receiver pairs that sense the presence of one or more data storage devices in read-range of the antenna.

The system includes radio frequency reader electronics and software operable by a user interface that enables the tracing of data storage devices in transit away from a location, returning to a location, or in transit within a facility. The in-transit tracing of devices includes devices contained within a case or on a trolley that are configured for shipment to a secured storage facility. In this regard, the multiple devices can include devices from different departments of a business entity, or devices from one or more business entities that are gathered together, for example, in the storage facility, and packed in a case for transit to another location. The electronic data storage device tracing system provides for the unique identification of each device in transit, which enables monitoring of the location of the device and the time at which the device enters or leaves the location. In addition, the electronic data storage device tracing system provides for the identification of devices that might be misplaced in a library shelving such devices, for example when an automated handler (or robot) misplaces or drops a device. To this end, the electronic data storage device tracing system is configured to identify the device by its stored data and by its VOLSER and/or serial number(s), thus enabling identification of devices that are misplaced enroute to a library carousel.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments of data storage device tracing and tracking systems discussed herein. Therefore, it is intended that this invention be limited only by the claims and the equivalents thereof.

What is claimed is:

1. An electronic data storage device tracing system comprising:
at least one data storage device including:
a housing providing device data and an RFID tag coupled to the housing, the RFID tag including an electronically stored identification number; and
a reader system including:
a user interface in communication with a reader unit, the user interface including a database, the reader unit configured to read the identification number from the RFID tag, and the user interface configured to append the read identification number to the database;
wherein the user interface is operable to associate the identification number of the RFID tag to a specific one of the at least one data storage device according to the device data and configured to trace each data storage device in transit relative to the reader system.

2. The system of claim 1, wherein the RFID tag comprises a memory chip including a unique 64 bit electronically stored identification number.

3. The system of claim 1, further comprising:
multiple data storage devices contained in a case, each of the devices including an RFID tag provided with a unique electronically stored identification number;
wherein the user interface is operable to append each identification number for each of the multiple data storage devices to the database in less than about 5 seconds.

4. The system of claim 3, wherein the multiple data storage devices are contained in the case to have a spacing between adjacent devices of less than about 2 inches, and the user interface is operable to append each identification number for each of the multiple data storage devices to the database in a time frame of between about 0.5 to 5 seconds.

5. The system of claim 1, further comprising:
a label attached to the housing, the label printed with the device data to include a VOLSER number, and the RFID tag configured to electronically store the VOLSER number and the identification number.

6. The system of claim 5, further comprising:
multiple data storage devices contained in a case, each of the devices including the label printed with a VOLSER number and the RFID tag having a unique electronically stored identification number, the RFID tag configured to electronically store the VOLSER number and the identification number;
wherein the user interface is operable to append the VOLSER number and the identification number for each of the multiple data storage devices to the database in less than about 10 seconds.

7. The system of claim 6, wherein the multiple data storage devices are contained in the case to have a spacing between adjacent devices of less than about 2 inches, and the user interface is operable to append the VOLSER number and the identification number for each of the multiple data storage devices to the database in a time frame of between about 1 to 6 seconds.

8. The system of claim 6, wherein about 20 data storage devices are contained in the case and have a spacing between adjacent devices of about 1 inch, and the user interface is operable to append the VOLSER number and the identification number for each of the multiple data storage devices to the database in a time frame of about 2.5 seconds.

9. The system of claim 6, wherein the reader unit is configured to scan the VOLSER number and the identification number from the RFID tag for each of the multiple data storage devices contained in the case, and the user interface is programmed with an expected number of data storage devices contained in the case.

10. The system of claim 9, wherein the user interface is configured to prompt a user if the expected number of data storage devices contained in the case does not equal a scanned number of data storage devices contained in the case.

11. The system of claim 6, wherein the multiple data storage devices comprises more than 100 data storage devices contained in a movable trolley, and further wherein the user interface is operable to append the VOLSER number and the identification number for each of the multiple data storage devices to the database in less than about 60 seconds.

12. The system of claim 1, wherein the reader unit communicates with a substantially rectangular reader antenna comprising a quality factor of about 15.

13. A method of tracing data storage devices entering/exiting a location, the method comprising:
staging at least one data storage device at a reader system upon arrival/departure of the at least one data storage device at the location;
radio frequency reading an identification of each data storage device with a reader unit of the reader system; and
tracing transit of each data storage device relative to the reader system.

14. The method of claim 13, wherein the at least one data storage device comprises multiple data storage devices, each device including an RFID tag programmed with a unique electronically stored identification number.

15. The method of claim 14, wherein radio frequency reading an identification of each data storage device comprises appending the unique electronically stored identification number for each of about 20 data storage devices to a database in a time frame of between about 0.5 to 5 seconds.

16. The method of claim 14, wherein each device includes a label printed with a VOLSER number, and each RFID tag electronically stores the VOLSER number and the identification number.

17. The method of claim 16, wherein radio frequency reading an identification of each data storage device comprises appending the VOLSER number and the identification number for each of about 20 data storage devices to the database in a time frame of between about 1 to 10 seconds.

18. The method of claim 13, wherein radio frequency reading an identification of each data storage device comprises providing the reader system with a reader antenna comprising a continuous ribbon conductor folded to define a generally rectangular shape.

19. The method of claim 18, wherein the ribbon conductor comprises a width between about 0.22-0.6 m and a length between about 0.4-0.8 m.

20. The method of claim 19, wherein radio frequency reading an identification of each data storage device comprises passing current of about 1.3 amps (RMS) through a ribbon conductor having a width of about 0.37 m and a length of about 0.50 m, the ribbon conductor comprising an antenna inductance of about 1.11 H.

21. The method of claim 20, wherein the ribbon conductor comprises a quality factor Q of about 15.

22. The method of claim 13, wherein tracing transit of each data storage device comprises:
providing a user interface in communication with the reader unit; and
prompting a user with the user interface if an expected number of in-transit data storage devices does not equal a number of data storage devices arriving/departing the location.

23. The method of claim 13, wherein staging at least one data storage device at a reader system comprises:
providing an antenna pad of the reader system with a pressure-sensing switch;
placing a container of data storage devices onto the antenna pad; and
closing the pressure-sensing switch with the container and initiating a radio frequency scan of each data storage device within the container.

24. The method of claim 13, wherein staging at least one data storage device at a reader system comprises:
providing an antenna pad of the reader system with a foot switch;
placing a container of data storage devices onto the antenna pad; and
stepping on the foot switch and initiating a radio frequency scan of each data storage device within the container.

25. A tracing system configured to trace a container of data storage devices, the tracing system comprising:
an antenna in communication with a reader unit configured to radio frequency read an identification number from an RFID tag coupled to the container identifying the container and its contents; and
a reader system including:
a user interface in communication with the reader unit, the user interface including a database, the user interface configured to append the read identification number to the database;
wherein the user interface is operable to associate the identification number of the RFID tag with the container, and configured to trace the container in transit relative to the reader system based upon information appended to the database.

26. The tracing system of claim 25, wherein the antenna is a loop antenna.

27. The tracing system of claim 26, wherein the antenna comprises a continuous ribbon conductor folded to define a generally rectangular shape.

28. The tracing system of claim 27, wherein the ribbon conductor comprises a width between about 0.22-0.6 m and a length between about 0.4-0.8 m.

29. The tracing system of claim 26, wherein the loop antenna comprises a high frequency antenna having a width of about 0.37 m, a length of about 0.50 m, and is characterized by an antenna inductance of about 1.1 μH.

30. The tracing system of claim 26, wherein the antenna comprises a quality factor Q of about 15.
